(19) United States
(12) Patent Application Publication
(10) Pub. No.: US 2011/0301767 A1
(43) Pub. Date: Dec. 8, 2011

(54) AUTOMATED LANDSCAPE WATERING RESTRICTIONS

(76) Inventor: George Alexanian, Fresno, CA (US)

(21) Appl. No.: 13/159,071

(22) Filed: Jun. 13, 2011

Related U.S. Application Data
(63) Continuation-in-part of application No. 12/011,801, filed on Jan. 30, 2008, now Pat. No. 7,962,244.
Application No. 12/011,801 is a continuation-in-part of application No. 11/879,700, filed on Jul. 17, 2007, now Pat. No. 7,844,368.
Application No. 11/879,700 is a continuation-in-part of application No. 11/336,690, filed on Jan. 20, 2006, now Pat. No. 7,266,428.
Application No. 11/336,690 is a continuation-in-part of application No. 10/824,667, filed on Apr. 13, 2004, now Pat. No. 7,058,478.
Application No. 10/824,667 is a continuation-in-part of application No. 12/955,839, filed on Nov. 29, 2010.
(60) Provisional application No. 60/465,457, filed on Apr. 25, 2003.

(51) Int. Cl. A01G 25/16

(52) U.S. Cl. 700/284

(57) ABSTRACT

Many water districts, municipalities and other governmental authorities have implemented local irrigation and watering restrictions to conserve water. These watering restrictions generally change from season to season, with different schedules being effective at different time periods during the year. Embodiments of the present invention provide for automatic implementation of these seasonal or periodic watering restrictions to prevent watering when it is not allowed, and include the capability of updating the currently implemented restrictions according to the date or time of year. Embodiments of the present invention may be provided in controllers, in modules that are added on to existing controllers, or in modules that are plugged into existing controllers with or without smart technology. Other embodiments provide for broadcast of the watering restrictions and/or signals that are received and implemented by controllers, add-ons or plug-ins of the present invention.

### DOMESTIC PRIORITY

This is a continuation-in-part of U.S. patent application Ser. No. 12/011,801 filed Jan. 30, 2008, which is a continuation in part of application Ser. No. 11/879,700 filed on Jul. 17, 2007, now U.S. Pat. No. 7,844,368, which is a continuation-in-part of U.S. Utility patent application Ser. No. 11/336,690 filed on Jan. 20, 2006, now U.S. Pat. No. 7,266,428, which is a continuation-in-part of U.S. Utility patent application Ser. No. 10/824,667 filed on Apr. 13, 2004, now U.S. Pat. No. 7,058,478, which claims the benefit of U.S. Provisional Application No. 60/465,457 filed on Apr. 25, 2003, all of which are incorporated herein in their entirety by this reference. This application also claims the benefit of U.S. patent application Ser. No. 12/955,839 filed on Nov. 29, 2010, of U.S. Provisional Patent Application No. 60/899,200 filed on Feb. 1, 2007, and U.S. Provisional Patent Application No. 61/000,066 filed on Oct. 22, 2007, all of which are also incorporated herein in their entirety by this reference.

### FIELD OF THE INVENTION

The present invention relates to automated landscape irrigation, particularly regarding municipally restricted or regulatory authority established schedules of allowed watering times to save water and reduce the infrastructure pumping and water delivery load. These mandated restrictions have heretofore required manual periodic adjustments for year round compliance, with little success without a concerted policing and fining effort by the local municipalities.

### BACKGROUND OF THE INVENTION

Landscape water accounts for 50-70% of all the residential water use in the West. Landscape water conservation is required for two purposes. The first is to save water, a limited natural resource. The second is to reduce the load on the pumping and water delivery capacity to preserve adequate water pressure for irrigation system efficiency without incurring massive infrastructure upgrading costs.

Two methods have heretofore been devised to meet one or both of these water conservation goals:
1. The use of weather based smart irrigation controllers or soil moisture sensors. A smart controller can vary its irrigation schedules or its station operating (run) times based upon current or historical local environmental conditions. Soil moisture sensors can determine when soil below ground level requires additional irrigation as determined by means of soil moisture probes or sensors.
2. The use of municipally restricted or regulatory authority imposed watering schedules. Typically, a municipality will publish mandated watering restrictions, for either or both of infrastructure saving reasons and/or drought conditions. These restrictions have been in the form of allowed or not allowed watering days of the week and/or times of the day.

Several uses, methods and apparatus as well as advantages and shortcomings of smart technology have been previously discussed in the present applicant's earlier patents including U.S. Pat. Nos. 7,058,478, 7,266,428, 7,844,368, and pending applications Ser. Nos. 12/011,801 and 12/955,839 (incorporated herein), as well as elsewhere. In addition, the U.S. Department of the Interior, Bureau of Reclamation has published a complete listing (as of September 2009) of all “Weather and Soil Moisture Based Landscape Irrigation Scheduling Devices”.

It is to be appreciated that it may be desirable for irrigation controllers, add-ons or plug-in to incorporate automated watering restrictions in combination with any of the weather based or soil moisture based devices which have heretofore required periodic manual adjustments.

In order to conserve water, the irrigation industry, state government water related agencies, and local water districts have encouraged for several years the use of smart irrigation controllers to save water. Smart controllers referred to adjust their irrigation schedule depending upon local environmental conditions. Most of these smart irrigation controllers use evapotranspiration (ET) as the basis for determining the landscape watering needs. These irrigation related measures have been taken because western states frequently experience drought conditions, making water supplies critical. Residential landscape irrigation accounts for 50% to 70% of all residential water use in California, Nevada, and Arizona. Current attempts to generate public education and interest for water conservation using “smart”, irrigation controllers and modules that adjust themselves to accommodate for varying environmental conditions throughout the year, have not proven effective. A 2009 study of 3112 ET based smart controllers performed by AquaCraft showed that only an average of 6.3% of the landscape water was saved in one year over the previous year, with 47% of the controllers using more water with ET controllers than with conventional controllers. While theoretically irrigation efficient, they have not solved the problem of conserving significant water due to their extremely low voluntary user and installer participation and disappointing results primarily due to their complexity.

For example, the Los Angeles Metropolitan Water District (MWD) and its twenty six associated water districts provide water to 3.5 million residential and commercial customers in Southern California. To promote water conservation, the MWD has been promoting the use of “smart” irrigation controllers that adjust themselves to changing daily weather conditions, since customers generally fail or forget to adjust their non-smart irrigation controllers on their own. MWD's associated water districts have either provided a variety of smart controllers from well-known manufacturers either free of charge, or rebated them up to 100%. The MWD reports that after 3 years of their smart controller rebate programs, less than 10,000 customers of the 3.5 million have tried to use these smart controllers. Of these, it is estimated that no more than 50% are properly used in their smart mode. This translates to far less than 1% effective usage, which would produce minimal water conservation. Another large water district, the Southern Nevada Water Authority (SNWA—which includes Las Vegas, Nev.), reports that in over two years, fewer than 100 controllers have been rebated in an area encompassing about 500,000 addresses. Other water districts report similarly poor response to smart controller programs. Some reasons for these mediocre results are set forth below:
1. Programming some smart controllers can be complex. In addition to conventional programming that requires entry of watering days, start times and watering durations, ET-based controllers require entries of precipitation rates, crop coefficient factors, soil type, slope, percentage of shade, and/or other information which is not readily available to homeowners.
2. Landscape maintenance contractors are reluctant to install such systems due to the numerous call backs to reprogram or re-explain smart controller programming to their customers.
3. Landscape contractors and landscape maintenances firms hesitate to train their personnel to learn to program as many as 20 different controllers in order for them to explain it to their residential and commercial customers. The high turnover rate of personnel makes it non-cost effective to train their installers.
4. The reluctance for a homeowner to trust tens of thousands of dollars of their landscaping to a controller they do not understand or cannot program.
5. Homeowners are used to seeing their controllers start cycles at certain times of the day on certain days of the week. Not observing irrigation causes them to wonder if their system is working.
6. California bill 1881 has postponed the enforcement of its mandatory smart controller requirements to January 2012, removing the urgency to convert to smart controllers.
7. Low cost of water in many areas due to government subsidies.
8. Lax or inadequate enforcement of water rules.

Separate from the need for water conservation, to address infrastructure shortcomings such as pumping, water delivery, and operating water pressure, some communities have limited the hours and days of allowable irrigation by specifying, for example, even or odd street address watering schedules, watering groups, times during the day when watering is prohibited, limiting watering to even or odd calendar days, or certain interval(s) of days, etc. In most instances, after an initial education period, these methods have proven to be easier to adhere to and more effective in water conservation than in particular smart ET controllers. The problem with this voluntary approach is that it still requires the homeowner or landscape contractor responsible for the maintenance of commercial sites to return to each site a number of times a year to manually reprogram each controller, in addition to their normal maintenance responsibilities. The SNWA estimates that near full compliance to their mandated watering schedules of allowed (or restricted) watering schedules would save at least 10% of the entire annual water needs (residential, commercial and industrial) in Clark County Nevada, which includes Las Vegas. This is important because the cost of upgrading the infrastructure or importing water from the Northern Sierra Nevada could run into the billions of dollars.

Based upon a study sponsored by the Irrigation Association, most irrigation users are not willing, incapable or neglect to change their schedules as required during the course of the year. It is therefore desirable to provide inexpensive, easily installable, easily programmable, automated water restrictions in add-ons, plug-ins, or within controllers themselves, whether smart or non-smart. This approach has the potential to save many times more real water than any existing smart controller

In addition, in locations with rapidly increasing population, these devices would alleviate the pumping and delivery problems of the available water thereby also saving pumping energy costs. Energy and water are two resources that are critical to any community that need to be conserved and managed. Energy conservation has been promoted by electric utilities in many communities for years in the following ways:
1. In California in the 1990's, Pacific Gas and Electric and Southern California Edison offered programs to agricultural customers that significantly reduced their electric rates if they abstained from using their irrigation pumps during certain times of the day. This was a very effective way to save agricultural pumping energy.
2. Electric utility companies offered rate incentives for residences that reduced their power usage during peak times of the day, particularly in the summer. It was less expensive to offer power credits or reduced rates than to build new power plants and lines.
3. These power utilities companies also had “rolling brownouts” that selectively turned off parts of cities to save energy during heat waves that exceeded the power grid demand capabilities of power generation and delivery.
4. Today, certain electric companies are proposing to control the thermostats during certain times of the day to help conserve energy. This would be presumably accomplished with the installation of a wireless device that can control either the heater/air conditioner, or the temperature setting itself.

All of the above attempts are exclusively related to energy conservation during certain times of the day. It would therefore be desirable to conserve both water and energy used for landscape irrigation by reducing the use of additional pumps or larger horsepower pumps by providing an inexpensive, easily installable, easily programmable, non-smart, automated, irrigation methods and apparatus to automate implementation of governmentally established watering restrictions.

### Description of the Prior Art

Water districts and municipalities have been periodically restricting landscape irrigation for decades either to save water or relieve the water load demand based upon the water pumping and delivery capabilities available. Typically, an even or odd designation is made by street address corresponding to the even or odd day of the month. Correspondingly, controller manufacturers have incorporated this even-odd watering capability into irrigation controllers. Upon initial setup of the irrigation controller, the user designates his (street address) ending number, so that, corresponding to the even or odd numbered day of the month, irrigation will or will not occur. This method tends to reduce the stresses on the water pumping and water delivery infrastructure if followed faithfully. However, depending upon the time of the year, geographic location, water availability, and existing infrastructure, it is common for those watering restrictions to vary seasonally as required by the governing authority or water district. This existing even/odd or other watering restriction would still require the user to manually change the watering days and/or times of day several times a year in their irrigation controllers. Fines are commonly levied if watering occurs during a non allowed day of the week or a non allowed time of day.

In terms of smart water technology, large number of new controllers, add-ons and plug-ins are now available that can adjust their irrigation schedules based upon weather conditions. An example of a module add-on is the invention disclosed in U.S. Pat. No. 6,892,114. This patent discloses monitoring of the inrush and holding currents output from the controller in order to “learn” the initial programmed station run times. After calculating desired run times from supplied environmental parameters, the controller outputs are cut off at the new calculated time. The cut offs fluctuate from day to day depending on the environmental parameters and the calculations. In another embodiment, ET values are accumulated until a minimum threshold value is reached before irrigation occurs. In U.S. Pat. No. 6,895,987, an irrigation scheduler automatically modifies irrigation schedules of installed irrigation controllers to affect irrigating of the landscape based on the water requirements of the landscape plants, and calculates a daily ET value which is then used to control the output of the controller. Publication No. 2004/0039489 describes wireless transmission of various environmental data such as temperature, humidity, solar radiation, wind, and rainfall to calculate an ET value in a module attached to the output of an irrigation controller which then modifies its schedule. This design is manufactured by Weather Reach and commercially marketed by Rain Bird.

The recent Hunter ET System and Solar Sync, and the Irritrol Climate logic system are examples of smart plug-in modules that can control an existing controller's irrigation cycles to make them smart based upon environmental conditions.

The September 2009 edition of “Weather and Soil Moisture Based Landscape Irrigation Scheduling Devices” (published by the U.S. Dept. of the Interior, Bureau of Reclamation) describes most of the currently manufactured “smart” irrigation control devices. Ground moisture sensors systems, as controllers and add-on devices are also disclosed in the Bureau of Reclamation publication such as those provided by Irrometer, Acclima, Dynamax, Lawn Logic, and Watermonics. These devices measure soil moisture to determine the need for irrigation.

It is apparent from the foregoing that a number of “smart” controllers, add-on and plug-in modules are currently available that are designed to manage the outputs of irrigation controllers based on changing environmental conditions. However, all of these inventions are dependent upon environmental factors or ground moisture to calculate or determine the time, duration, or frequency of irrigation cycles. In contrast, embodiments of the present invention when used independent of smart technology do not require real time environmental data, any additional equipment such as weather stations, stored historical weather data, transmitted or calculated weather data, or any form of smart technology to control an irrigation controller's output(s).

### SUMMARY OF THE INVENTION

Heretofore, landscape watering restrictions have been manually set into irrigation controllers that frequently required seasonal or periodic manual adjustment during the course of the year. The present invention provides simple automated methods and apparatus for implementing seasonal or periodic governmental watering restrictions in controllers add-ons and plug-ins. Embodiments of the present invention accomplish water conservation that balances the infrastructure demands for water delivery by facilitating easy compliance with a community's watering regulations and restrictions as imposed by local governmental authorities. The present invention saves water and energy, improves irrigation efficiency, and saves the cost of infrastructure upgrading using simple methods and apparatus that have heretofore not been contemplated with any existing technology. Some physical embodiments include seasonally automated water restriction schedule(s) within controllers, add-ons or plug-ins, or centrally located units that broadcast to any of these. Embodiments of the present invention also provide for automated selection from multiple pre-programmed watering schedules based upon location. Embodiments of the present invention may also be incorporated into or used with smart controllers for complete automation of water conservation.

When the term “schedule” or “cycle” is used in the context of an “irrigation” or “watering” schedule or cycle herein, unless the context indicates otherwise, this refers to an irrigation or watering schedule or cycle of a controller. For example, a controller having four valves may be programmed to water every day beginning at 6:00 a.m., with each valve being operated for 15 minutes. This is an example of a daily irrigation or watering schedule having a four-part cycle that lasts for one hour.

When the term “restricted” is used with an irrigation or watering schedule, unless the context indicates otherwise, this refers to mandated restrictions on irrigation or watering schedules from a governmental body or other authority. For example, a certain city may prohibit watering after 6:30 a.m. every day during the summer. This is an example of a restricted schedule, which would prohibit some of the watering of the above example (operation of the last two valves) during the summer.

In addition, it is to be appreciated that unless the context indicates otherwise, a restricted watering schedule may refer to either (i) a single schedule (for example, an annual schedule) that may or may not include multiple shorter seasonal or periodic sub-schedules covering limited time periods (for example, four 3-month schedules from June-August, September-November, December-February, and March-May); or (ii) any one of such shorter seasonal or periodic sub-schedules. Accordingly, embodiments of the invention may receive a single schedule containing numerous sub-schedules, and automatically adjust to the applicable sub-schedule according to the current date/time. Alternatively, embodiments of the invention may receive multiple separate schedules or sub-schedules, and automatically select a different sub-schedule when it becomes applicable according to the current date/time, and adjust irrigation accordingly.

Another distinction should be made when “allowed” or “not allowed” watering times is discussed in reference to restricted watering schedules. Some governmental entities (such as water districts) designate watering days or times of day for certain groups, which are the allowed watering days for a particular group, and which inherently imply non-watering days or times of day for the other groups. It is to be appreciated that when the term “allowed” is used with respect to certain restricted watering days or times, unless the context indicates otherwise, this inherently excludes the remaining watering days or times as “not allowed”. For example, if there are allowed watering times during a day, then the rest of the time of the day watering is not allowed; or if there are allowed watering days of the week, the rest of the days of the week watering is not allowed.

In some of the preferred embodiments, a programmable add-on module is provided that is easily attached to any existing irrigation controller. The existing controller or its add-on may be powered by batteries, AC, DC, solar, or ambient light, and the controller may be a conventional or smart controller. The irrigation system may also be a central system where a central unit or computer directs the slave controllers in the local community when to irrigate. The module of the present invention may be powered by any suitable source including without limitation batteries, AC, DC, solar, ambient light, etc. A microprocessor incorporated within the module keeps the current time of day, calendar, and contains one or more schedules of watering restrictions or allowed watering time schedules determined by a local governmental authority. In some embodiments such as an add-on, the device is installed in series on the common electrical line between the controller and its valves, and is capable of breaking that line to prevent the valve solenoids from activating, thereby only allowing watering during the designated days or hours, depending upon the requirements imposed by the local governmental authority. These requirements may allow watering at different times depending upon such things as the address or location where the module is installed, the season, the date and/or the time of day. In these embodiments, only two wires need to be attached to any existing controller. These watering restrictions may then be periodically or seasonally automated for convenience according to the present invention.

In some embodiments, the add-on or plug-in module may be pre-programmed with one or more different pre-determined watering restrictions as established by a local governmental authority. Entering a zip code may be used to identify the location, thereby selecting the appropriate restrictions for that community or water district. For example, the identified or selected municipality may have watering restrictions as follows: during designated summer months, watering of even-numbered addresses is allowed on certain days and odd-numbered addresses allowed on different days, but no watering is allowed at any address during certain daylight hours; during non-summer months different watering days and times are allowed. An embodiment of a module of the present invention may have four sets of pre-programming schedules (or one set of four schedules), and a switch, button or other means on the module to select one of them: (1) summer-odd, (2) summer-even, (3) winter-odd, and (4) winter-even. Depending on the address where the module is used (even or odd) and the season of the year (twice a year, or four times a year, or any other periodic interval during the year), the user can easily set the module so that it follows the correct watering schedule for that particular time and location by selecting or programming the particular watering restrictions. It is to be understood that in preferred embodiments, this invention encompasses the capability to have pre-programming for additional restrictions depending upon the regulations of the local government. It may also be possible that one or more drought stages may be specified within the water district which may also be pre-programmed into the controller, module, or add-on.

More sophisticated embodiments may include an internal clock that is set to the correct date and time in order to automatically switch between pre-programmed summer, fall, winter, spring or other watering schedules. Such embodiments may not include any switches or switch settings, or they may include simple switches or settings such as “even-odd” to designate the address of the location. In other embodiments, separate modules may be provided without switches, for example one containing pre-programming for use with even-numbered addresses, and another containing pre-programming for use with odd numbered addresses. In other embodiments, additional programming and/or separate modules may also be provided for commercial as opposed to residential use, if different restrictions are imposed for commercial and residential properties by the local governmental authority. It is to be appreciated that multiple modules, or multiple switches, switch settings, buttons, or the like may be provided with modules of the present invention, to provide a selection of pre-programming options, and that a wide variety of different combinations of switch-selectable options may be implemented on different modules with or without an internal clock.

In other embodiments, the modules of the present invention may be provided with an input for receiving updated programming In some embodiments, such input may be in the form of a connector (e.g., USB, Ethernet, telephone jack, etc.) to which a cable is attached to download programming from an external source such as a USB flash drive (memory stick), computer or the Internet. This allows the programming in the module to be updated in the event of changes by the local governmental authority. In other embodiments, the module may include a reader that may receive a card, strip or other article having a magnetic strip or other means for holding data/programming that may be read and implemented by the module. These embodiments allow the local governmental authority to provide updates by simply mailing out cards, strips, or other convenient data transfer devices, by making programming updates available on line through the Internet, or by having a technician drop by to download the programming from a portable device.

In other embodiments, the module may be provided with a receiver that is capable of receiving a wireless transmission from another source to provide programming. The transmission may include initial programming from the local governmental authority, updated programming (e.g., for the current season), or emergency programming in the event the local governmental authority imposes unexpected restrictions (such as in the case of a worsening drought). The programming may be broadcast from a single central source, or from multiple sources, or technicians may travel through neighborhoods with transmitters to broadcast updated programming to locally affected areas.

In other embodiments, the module of the present invention may be attached to a master valve at a location to hydraulically disable the water supply at that location.

In other embodiments, the watering schedules of the local governmental authority may be incorporated within a controller, (conventional or smart) without the need for an external module to override or alter the controller's programmed watering schedules.

The present invention is unique in at least two respects. First incorporating one or more pre-programmed restricted watering schedules for specific locations which can then be automatically selected or selected by the user (for example, using a zip code); and secondly, and perhaps more importantly, the capability of the controller, add-on or plug-in to automatically vary the allowed watering days and times of day seasonally, periodically or by some other interval during the course of the year. A smart controller can automatically adjust itself to various daily environmental conditions without user input. The present invention automatically adjusts a controller, add-on, or plug-in according to identified or selected mandated schedules of government watering restrictions, and automatically updates and re-adjusts the controller, add-on, or plug-in at various times during the year with different restricted schedules as they become applicable.

It should be noted that automatically altering restricted watering schedules (allowed watering days and times of day based on seasonal or periodic local watering restrictions) may be provided, according to the present invention, in smart or conventional controllers, and smart or conventional add-ons or plug-ins. These seasonally adjustable watering restrictions are also suitable for non AC powered irrigation controllers, be they battery powered, solar powered, or ambient light powered.

It is therefore an object of the present invention to provide methods and apparatus (controllers, add-ons, plug-ins, and/or central systems) for implementing periodically changeable time of use (watering restriction) regulations from local governmental water authorities within their territories.

It is also an object of the present invention to provide methods and apparatus to identify and select one or more municipally restricted water schedules.

It is also an object of the present invention to provide methods and apparatus for easily implementing changes or updates to time of use regulations from local governmental water authorities within their territories. These apparatus may be controllers, add-ons or plug-ins or centrally broadcast systems.

It is also an object of the present invention to provide simple and effective methods and apparatus for water and energy conservation.

It is also an object of the present invention to provide simple, low cost, and effective methods and apparatus to alleviate significant infrastructure upgrade costs (pumping systems, water delivery systems, sewage treatment plants, etc.) by balancing water demands within communities.

It is also an object of the present invention to provide methods and apparatus that are simple enough that virtually any end user can afford, install, and/or program the invention without the need for an electrician or other professional. In many instances, the device may be provided free of charge by the local water agency. A very cost effective module that is simple to install and program, provided free of charge, that reduces, simplifies or eliminates user reprogramming and contractor call backs with no monthly service fee, greatly improves the likelihood of high compliance that will save significant money in terms of water, energy, and infrastructure upgrading.

It is also an object of the present invention to provide an add-on module, plug-in or controller that may be used with virtually any irrigation system anywhere in the world to implement time of use regulations from local governmental water authorities with only slight software modifications specific to a region or country.

It is also an object of the present invention to provide a built-in module for an existing controller for implementing time of use regulations from local governmental water authorities.

It is also an object of the present invention to provide an add-on module that may be used in conjunction with a master valve at a location to cut off the water supply at that location.

It is also an object of the present invention to provide controllers, add-ons, plug-ins or centrally broadcast systems that may be combined with smart watering technology.

Additional objects of the invention will be apparent from the detailed descriptions and the claims herein.

### BRIEF DESCRIPTION OF THE DRAWINGS

FIG. 1 is a block diagram of an embodiment of an add-on module of the present invention.

FIG. 1A illustrates an alternative embodiment of an add-on module of the present invention.

FIG. 1B illustrates an alternative embodiment of an add-on module of the present invention.

FIG. 1C illustrates an alternative embodiment of an add-on module of the present invention.

FIG. 2 illustrates sample SNWA watering schedules and changing allowed watering times of day.

FIG. 3 illustrates an exemplary display for an embodiment of the present invention having an SNWA watering schedule.

FIG. 4 is a block diagram of an embodiment of the invention powered by an internal battery.

FIG. 5 illustrates an exemplary embodiment of a switching means of the present invention modified to work with a battery powered irrigation controller.

FIG. 6 illustrates an embodiment of a module of the present invention on an electric common line to a master valve.

FIG. 7 illustrates an embodiment of a module of the present invention installed on a master valve that is not electrically connected to a controller, but capable of independently either allowing or inhibiting irrigation based upon pre-programmed watering restrictions.

FIG. 8 illustrates an embodiment of the present invention incorporated within a conventional or smart controller without the need of an add-on or plug-in module.

FIG. 9 illustrates an embodiment of a module of the present invention without a display or data entry means, with current time and date provided wirelessly (such as by an NIST clock signal). The illustrated exemplary embodiment has an override button and a means of indicating whether the output is “on” or “off” or in “override.”

FIG. 10A illustrates an embodiment of an updating device that is shown engaged with an embodiment of the module of the present invention.

FIG. 10B illustrates an embodiment of the present invention having an input connector for attachment to a cable from a source such as a personal computer.

FIG. 11 is a diagram of an embodiment of a local water infrastructure from water supply to the residential or commercial locations where embodiments of the present invention may be deployed.

FIG. 12 shows an embodiment of a module with multiple internal drought stages programmable with an internal dip switch.

FIG. 13 is a simplified block diagram of a centrally located transmitter sending signals to embodiments of the present invention.

FIG. 14 illustrates an embodiment of a plug-in module of the present invention that communicates directly with a controller microprocessor.

FIG. 15A illustrates an embodiment of an irrigation controller with restricted watering schedules governed by soil moisture sensors or probes.

FIG. 15B illustrates an embodiment of an irrigation controller with restricted watering schedules with a soil moisture sensor plug-in module that provides field soil sensor data to the controller. The field sensors can communicate by wired or wireless means with their probes.

### DETAILED DESCRIPTION

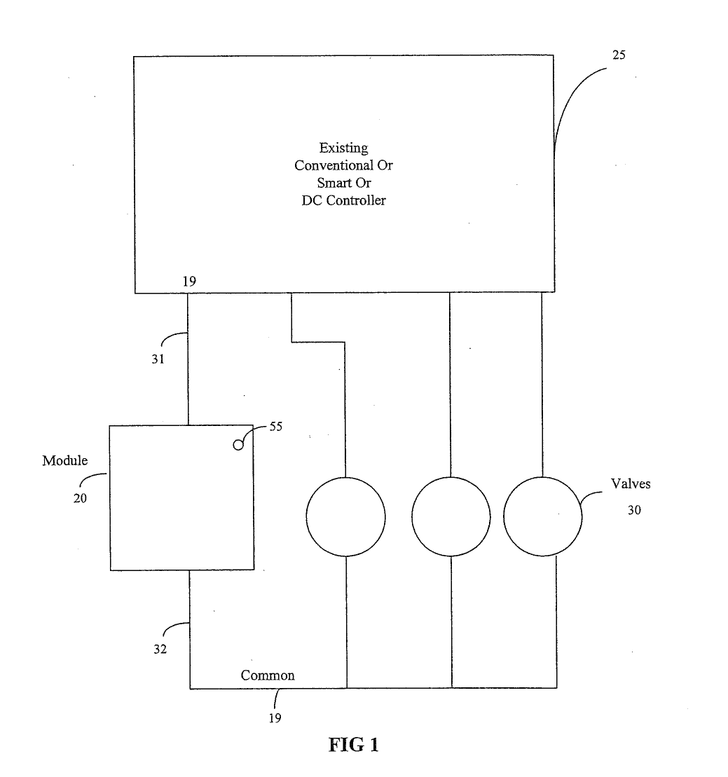

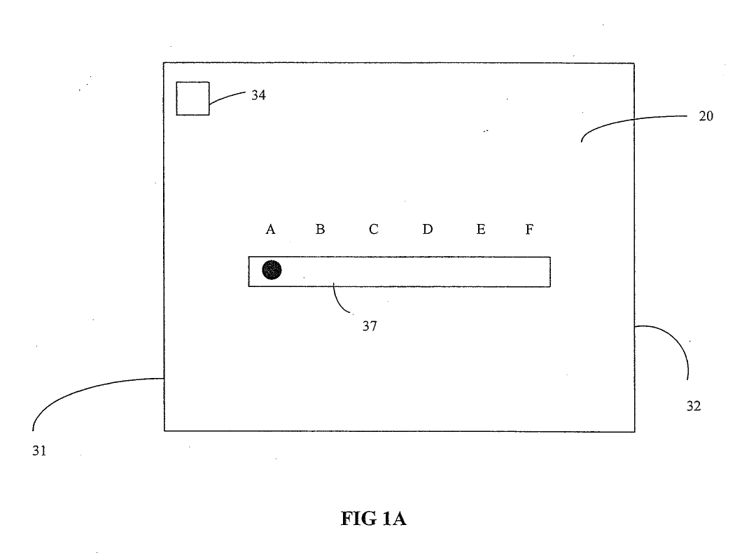

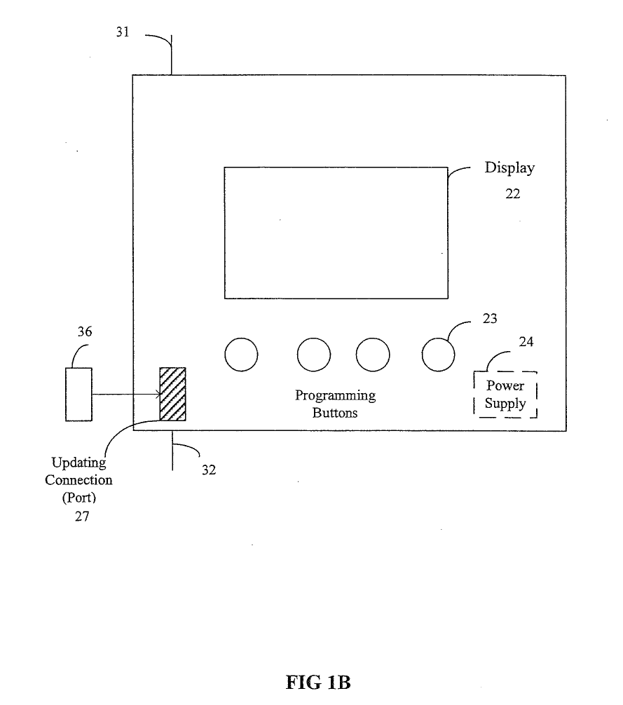

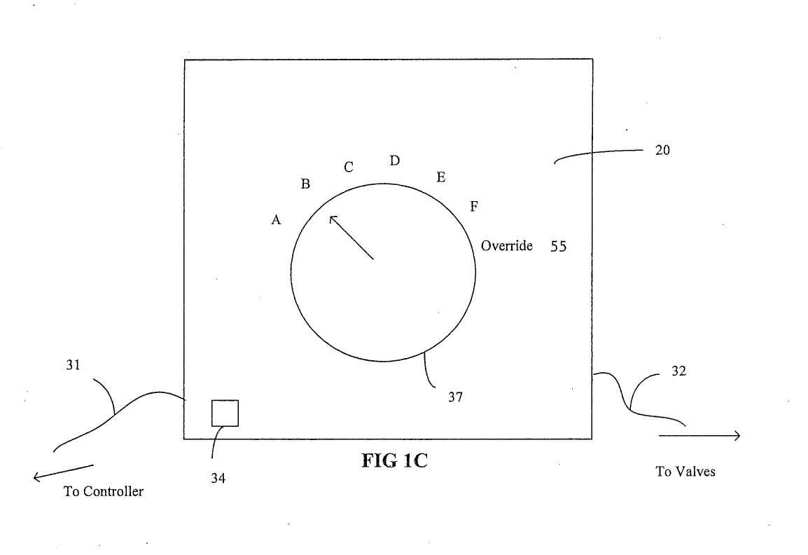

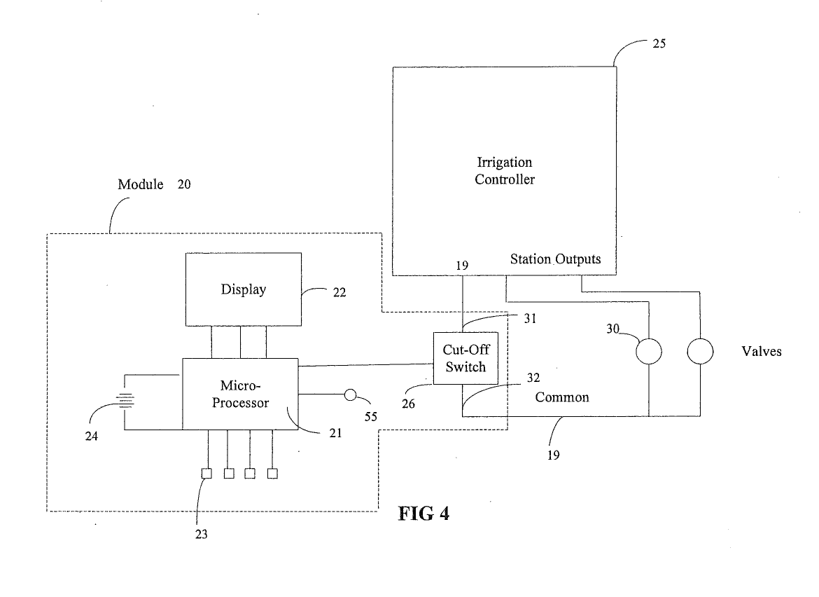

Referring to the drawings wherein like reference characters designate like or corresponding parts throughout the several views, and referring particularly to the illustrated embodiment of FIGS. 1 and 4, it is seen that this embodiment of the invention comprises an electronic module 20 that may be connected to the output common 19 of an existing controller 25. The embodiment of module 20 illustrated in FIG. 1B has a display 22, one or more data entry or programming buttons 23, and a power supply 24. It is to be appreciated that other embodiments of the invention may not include any display 22 and/or may not include any data entry devices 23. The power supply 24 may be in any suitable form, such as one or more lithium, alkaline, or rechargeable batteries, or the AC power from the controller may be used to operate the electronics of the module. A DC power supply for the module is preferred because it is electrically safe and isolated from primary and secondary surges.

In a preferred embodiment, two non-polarized wires or connections 31, 32 are provided for installation along the common output line 19 between the controller 25 and its valves 30. (See FIG. 1.). A module 20 of the present invention may be programmed with the time of day and calendar date, which may be pre-programmed before installation, or input after installation. In some embodiments, the water group (e.g. even/odd address, commercial/residential) may also be pre-programmed, or it may be input after installation. Embodiments where the date, time and water group are pre-programmed may not require data input buttons. A bypass function 55 may be provided that allows for overriding the output from the module for maintenance purposes or during periods of seeding and germination that require frequent daily short duration watering. In normal operation, a controller 25 may be programmed with its summer irrigation schedule which may call for every day watering. Controller common output 19 is attached to a module input line 31 which goes to a cutoff switch 26 inside the module. Depending upon the local watering schedules, the cutoff switch 26 inside module 20 breaks the controller output electric common 19 which is attached to the input 31 to the module to the valves 30, disabling their operation according to the restrictions of the local governmental water schedule programmed into the module 20. In alternative embodiments, the valve cutoff that is disabled by module 20 may be a mechanical device such as a relay, or an electronic device such as a triac.

FIG. 1A shows a multi-position slide selection of a watering group as a means of programming the module.

FIG. 1B shows programming buttons and a display as a means of programming the module.

FIG. 1C shows an exemplary rotary switch 37 with one or more selections for watering group designations, and an override capability 55 as an alternate embodiment. Rotating the switch 37 selects a pre-programmed watering schedule. One of the programming positions can be used for an override or bypass. In alternative embodiments, a rotary switch with more positions than currently needed may be provided to allow for future addition of watering schedules or groups.

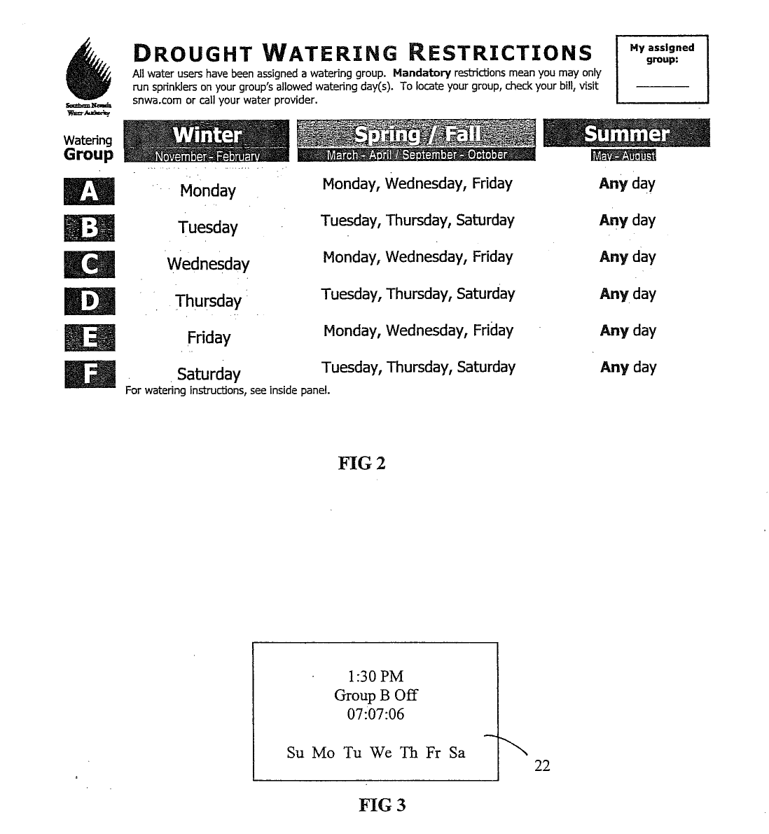

FIG. 2 shows the Southern Nevada Water Authority “Drought Watering Restrictions.” The SNWA has assigned areas of Clark County with six different watering groups with their respective watering schedules. For example, during the summer, all groups (A-F) can water any or all days. In a separate limitation, watering is prohibited from 11 a.m. to 7 p.m. during the summer months specified as May 1 until October 1. In the spring and fall, watering days are either Mondays-Wednesdays-Fridays or Tuesday-Thursday-Saturdays depending on the watering group designation. During the winter, only one day per week of irrigation is allowed, that day depending on the group. However, during winter watering is permitted during any time of day.

FIG. 3 shows an example of how a display might look for an embodiment of the invention adapted for use with the SNWA schedule. In this example, it is 1:30 p.m. on Jul. 7, 2006 and the screen shows that the module output is “Off” because even though it is during the summer schedule, it is off because the time of day is between 11 a.m. and 7 p.m. In this figure, the permitted watering days are shown along the bottom of the display as Su, Mo, etc. Because this shows an exemplary display during summer, all the days of the week are shown.

FIG. 4 is a block diagram of an embodiment of a time of use module of the present invention attached to an irrigation controller 25 that may be smart or conventional. The illustrated components in this exemplary embodiment of a module 20 are the display 22, microprocessor 21, power supply 24, input switches 23, and output cutoff switch 26. A common wire 31 from the module attaches to the controller common output 19. The wire 32 out of the module 23 attaches to the common of the valves 30. The power supply 24 for the module 20 can be from any suitable source, including without limitation, AC supplied from the controller, an internal battery, either permanent such as a lithium battery, or replaceable standard alkaline batteries, etc. This embodiment is shown with an internal battery 24. In a typical application, module 20 is programmed by means of input switches 23 with the time and date. The assigned watering group (even or odd street addresses, watering group, etc.) is programmed into the module either by means of the input switches 23, an internal dip switch, a rotary switch 37, or the like, that sets the assigned watering group. The module's cutoff switch 26 is either open or closed. A closed cutoff switch allows an irrigation cycle to take place if it is an allowed watering day or time of day. If it is not an allowed watering day, the cutoff switch is open. This cutoff switch 26 may be a mechanical device such as a relay, or a solid state device such as a triac. If it is a non allowed watering time or day, the controller output is cut off and the valves 30 do not receive the needed 24 volts AC voltage to operate. Input 55 to the microprocessor provides an override (bypass) either from an external override button, or from the rotary switch position as shown in FIG. 1C. The controller in FIG. 4 has one or more station outputs connected to each valve, while a single common typically connects all the valves.

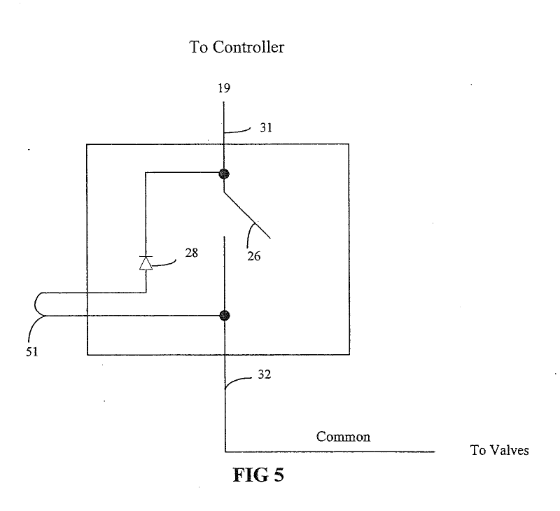

FIG. 5 shows an embodiment of a cutoff switch of a module 20 designed to operate either with an AC powered controller or a battery powered controller. An internal diode 28 in parallel with the cutoff switch 26 allows operation of the module with a battery powered controller. Battery powered controllers operate latching solenoids that are typically pulsed with a positive voltage to set (or latch) and a negative pulse to release. When the module indicates this is not an irrigation day or time for that watering group, the diode 28 allows a valve 30 to receive a negative pulse from the controller 25 to close the valve, but blocks positive pulses from the controller to open a valve, effecting compliance with the mandatory watering restrictions. When used with an AC controller, the jumper wire 51 (a loop external to the module) is cut off (severed) so that the diode 28 is taken out of the circuit; then, open switch 26 does not allow any valve to operate as described previously with reference to FIG. 4.

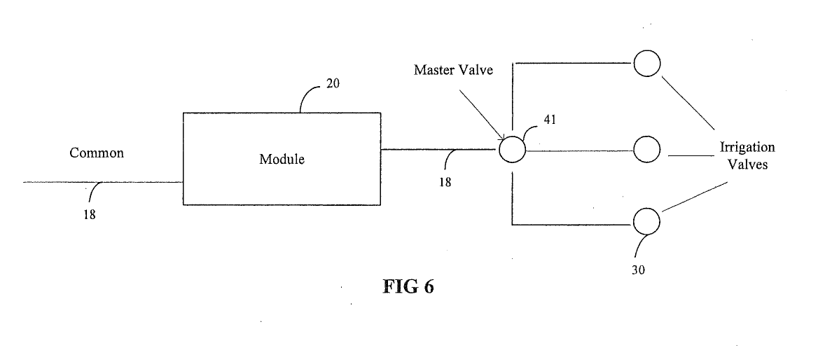

FIG. 6 shows an embodiment of a module 20 of the present invention, for either an AC or a DC system, mounted at a master valve 41 to break the common electrical line 18 operating the master valve. Disabling the master valve 41 hydraulically cuts off irrigation by all slave valves 30 in the same hydraulic system. In many commercial applications, it may be more convenient to place a module 20 at a master valve 41 rather than at a controller for greater accessibility for maintenance purposes.

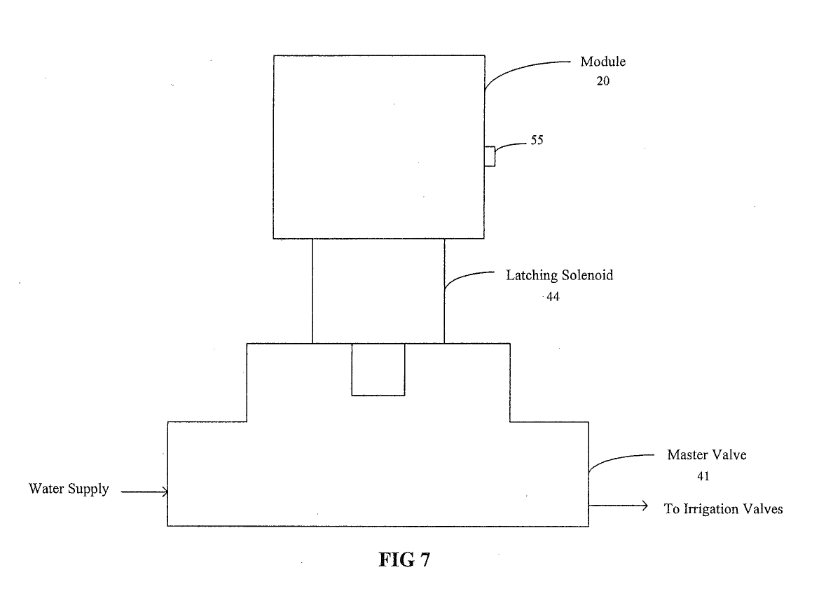

FIG. 7 shows an embodiment of a module 20 of the present invention directly mounted on a master valve 41 with its own latching solenoid 44 powered by the module which can shut off the master valve independent of an irrigation controller. In this case, the master valve 41 is not electrically attached to a controller 25. The programming in module 20 determines when master valve 41 is permitted to be open, allowing irrigation. An emergency override 55 may be provided to bypass the module 20 for repairs or maintenance. In most instances, master valves 41 are used in commercial applications.

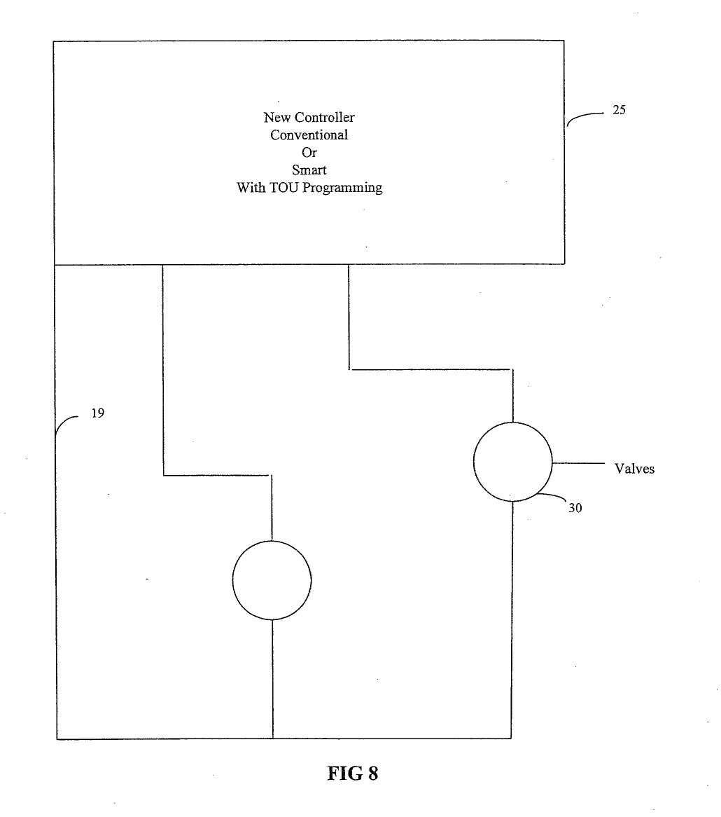

FIG. 8 shows an existing controller 25 (conventional or smart) in which the restricted watering schedules of the local governmental entity have been loaded into the controller 25. The watering schedules of the controller are determined in the usual fashion (by conventional or smart means), but the irrigation cycles are not allowed to run if the governmental watering schedules do not permit. One or more restricted watering schedules may be pre-programmed into the controller from which the schedule appropriate to that location is automatically selected. For example, a zip code or street address specifies the location, which in turn determines the governmental authority prescribed watering restrictions in effect for that location. Alternately, the restricted watering schedules for a specific location may be manually programmed into the controller by the user which can then automatically select the appropriate schedule and alter the restricted watering days throughout the year. For example, in the SNWA area, the controller may be programmed according to the watering restrictions shown in FIG. 2. First, the controller is programmed to irrigate every day during the summer, but automatically adjusts so as not to water between 11 am and 7 pm. Assuming that the user is in watering group “B”, the controller then automatically adjust so that from September 1, until October 31, the controller can only water on Tuesday, Thursday, and Saturday. Then starting November 1 until the end of February during the winter schedule, the controller automatically adjusts so it can only irrigate on Tuesdays, but at any time of the day. Finally, in the spring starting on March 1 until April 30, the controller automatically adjusts so that it can again water Tuesdays, Thursdays, and Saturdays. Automating the controller with watering restrictions will not only save water, balance the infrastructure demand, save the user the cost of water, save pumping energy, but also minimize the violations that would certainly occur with required manual changes to the allowed irrigation schedules. The SNWA reports that approximately 30% manual compliance has occurred and many fines have been imposed on violators, costing the customer money and the water district policing and administrative costs.

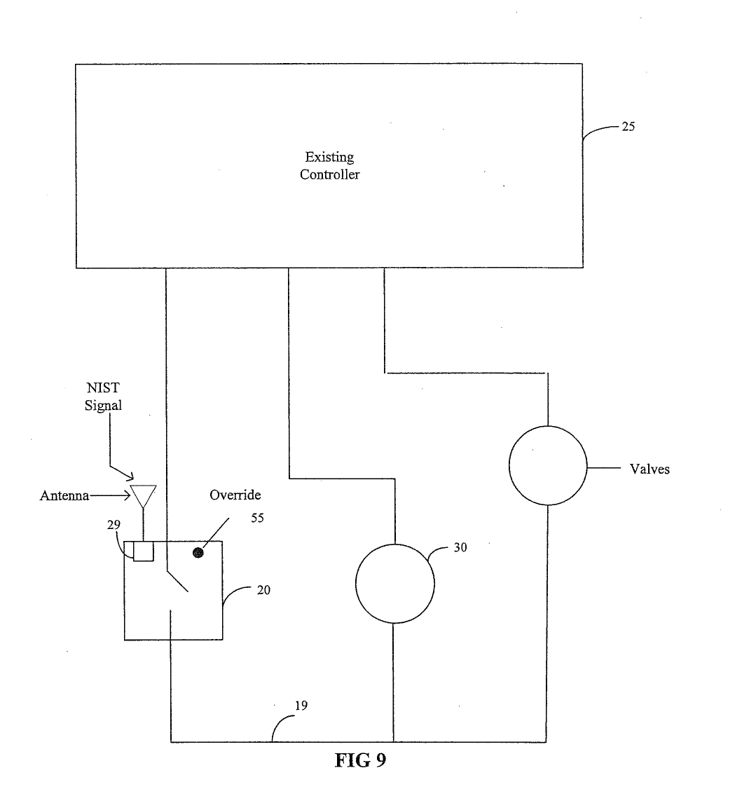

FIG. 9 shows an existing controller (conventional or smart, AC, DC, solar, ambient light powered, etc.) with an embodiment of a module of the present invention attached thereto having no display or data entry or programming buttons. A time signal such as found commonly with atomic clocks may be used to keep the time and date accurate, and the module may be pre-programmed with a specific allowed watering schedule that pre-empts irrigation by the existing controller 25. The time of day and day of the week is kept by the internal microprocessor that can keep time like a common wrist watch, and/or be updated wirelessly through a receiver 29 and antenna on module 20 by the time signal provided by WWVB from the NIST (National Institute of Standards and Technology).

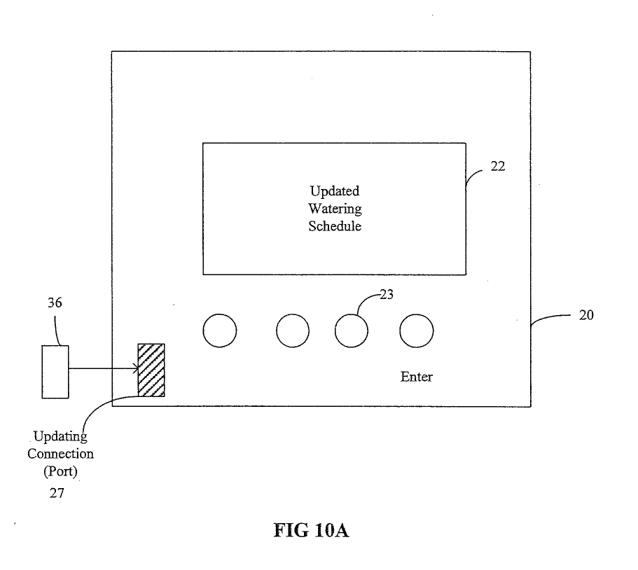

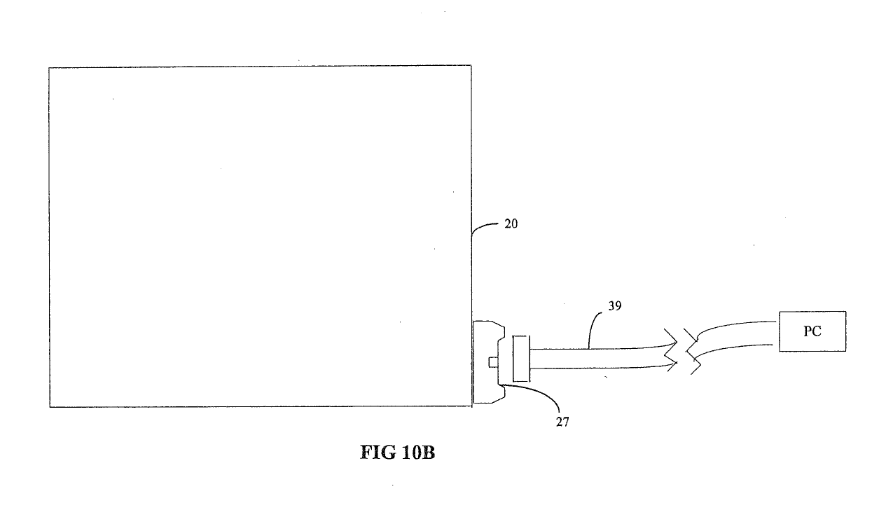

FIG. 10A shows an embodiment of a small data-transfer device 36 (such as a card, magnetic strip, USB flash-drive or memory stick, etc.) that can be plugged into or otherwise read/received by a module 20 of the present invention at data input port 27 to update or alter the existing watering schedules (TOU program). In some embodiments, the module of the present invention is pre-programmed with current local governmental watering schedules. In other embodiments, the initial programming may be provided using the data transfer device 36, and it may be changed or updated with different data on another data transfer device 36. For example, it is possible that at some future date, because of changing water supplies, worsening draught conditions, increased housing development or the like, the local governmental water authority may decide to alter the restrictions on landscape irrigation. The data transfer devices may be small enough that they may be mailed out by the local governmental water authority to users in the area subject to restrictions.

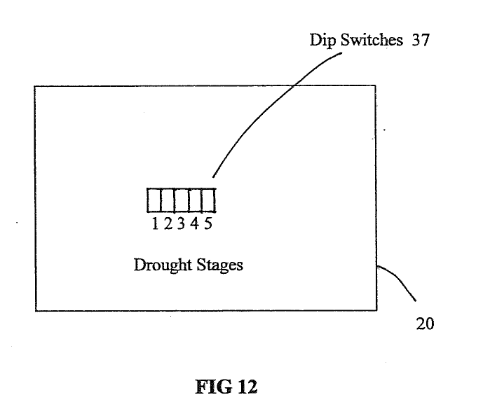

In some embodiments, the data transfer device 36 may be a small device about ½ inch square and less than 0.1 inches thick with the new watering schedules could be supplied to the water authority which can then mail it to the customers with instructions to connect it or plug it into the module 20. Upon making an electrical connection, the module 20 recognizes that a new program is available and the microprocessor 21 automatically downloads the revised watering restrictions without the need for user programming It is to be appreciated that multiple watering schedules may be provided in this way. As an alternative, if changing conditions are anticipated by the water authority and stricter contingency plans have been contemplated, the module 20 may already have the stricter watering restrictions pre-programmed and the user may simply access it for example by making a selection on a switch 37, or changing a setting (such as an internal dip switch). The stricter schedules may also be accessed by means of the front panel programming buttons or data entry switches 23, or by a selectable switch 37 (which may be rotary, slide, dip, etc.). FIG. 12 shows an exemplary embodiment having a DIP switch 37 used to select the pre-programmed drought stages. FIG. 10A shows a cable connection 39 to a PC for drought schedule upgrading.

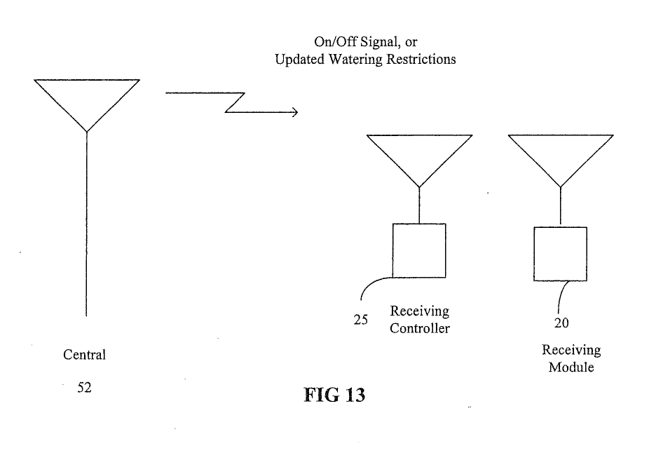

Other alternative embodiments of the present invention that allow for changing watering schedules provide initial or revised watering restrictions by wireless means to modules 20 that have receivers 29 monitoring for such commands Upon receipt, the new watering restrictions are automatically enabled within the module 20. Each module 20 may have its own unique address or identifier in order that modules 20 at different locations or addresses may be addressed separately and receive different watering instructions. The module 20 in these embodiments does not require a display or date or calendar since this information may be supplied with the transmission. It is to be appreciated that the transmission may be broadcast from a single central source, from multiple sources that are strategically placed at different locations, from traveling vehicles carrying broadcasting equipment, or from hand-held broadcasting devices. As shown in FIG. 13, an exemplary central station can broadcast watering schedules to every module 20 or controller in the broadcast area. The receiving modules 20 may act as cutoff switches to their respective irrigation controllers.

In other embodiments, the data transfer device itself 36 may include a receiver 29 for receiving updated watering schedules. The data transfer device is attached or plugged into a jack 27 on the module 20, and updated watering information is transmitted to receiver 29 and provided to module 20.

In alternative embodiments such as that shown in FIG. 10B, the initial, updated and/or emergency watering restrictions may be downloaded from the Internet, a computer (PC), or from some other source. In these situations, cable 39 is inserted into a connector or jack 27 on the module 20 through which water restriction programming is downloaded from an external source (Internet, hand held unit, computer, etc.) into the microprocessor 21 of the module. In emergency situations, the local water authority may provide an Internet address from which a user may download updated programming to its module 20. See FIG. 10A.

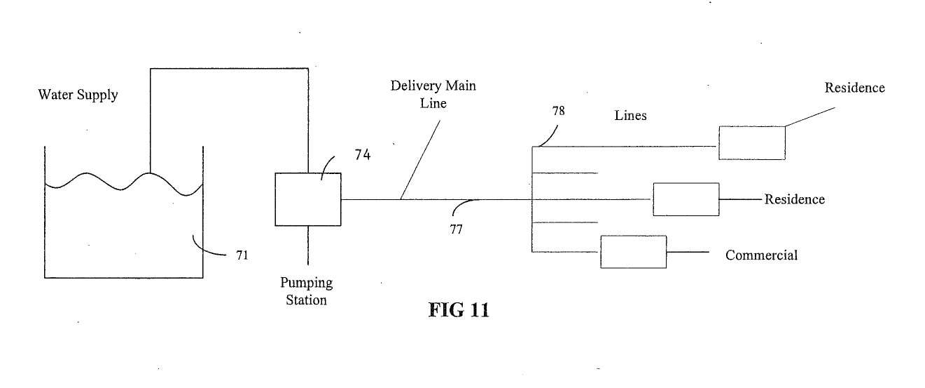

FIG. 11 shows a diagram of a typical exemplary pumping station with its infrastructure ending at a residence. The water supply 71 may be a dam, lake, or aquifer(s). Pumps 74 deliver water using water delivery main lines 77 to neighborhoods. Lines 78 deliver the water to individual residences, businesses, apartments, schools, etc. One or more pumps 74 are used to deliver the required water demand depending upon the season and time of day. Adequate pumping is required to deliver usable water pressure. In rapidly expanding communities, the pumping and main line capabilities may be inadequate to deliver a constant water supply at adequate pressure. The watering restrictions are normally implemented to balance the water demand load. Using fewer or smaller pumps saves energy and maintenance.

FIG. 12 shows an embodiment of a module 20 having multiple internal drought stages programmable with an integrated dip 37 (dual in line package) switch. In this embodiment, the switch 37 is connected to the module microprocessor. Five exemplary drought stages are labeled 1-5, with stage 1 possibly meaning no drought condition watering restrictions, stage 2 a mild drought watering schedule, and so on until stage 5 being the most extreme drought watering conditions and mandated watering schedules. Of course, other switches such as a multi-position slide switch, a small rotary switch, etc. may alternately be used for dip switch 37. An advantage to a hardware switch drought stage selection is that it does not require a front panel display or buttons for programming These embodiments may have a display with data entry buttons, or no display or data entry buttons as described in FIG. 9. The module may also keep its own date and time with an internal clock to include daylight savings time and leap year adjustments. This would eliminate the need for a receiver for the NIST clock signal. This method of selecting the draught stages could be incorporated in the simplest embodiments of the module with an internal clock and no display or programming buttons and no external NIST time signal or wireless receiver. The drought stages may also be programmed from the front panel with programming buttons and a display. The advantage of a display is that it can show additional information for the user, but does add some cost.

FIG. 13 is a simplified block diagram of a centrally located transmitter 52 that is capable of sending wireless signals to embodiments of the present invention. Each such embodiment requires a receiver 29 for receiving the wireless signal from transmitter 52. The signal may include updated watering schedules, such as changes in the drought stages, or seasonally or periodically varying allowed watering days or different allowed watering times of day to the controllers, or may provide a simple “on” or “off” command to modules 20. In alternative embodiments, each module 20 may be independently addressable, so that the signal may be directed to individual modules, to different groups of modules, or to all modules within the area, as desired. Some embodiments of the module of the present invention may include only an addressable receiver 29 and an on/off switch 26 used to break the common line 19 from a controller 25. These embodiments are completely controlled by the broadcasts from the water authority. It is to be appreciated that in alternative embodiments, the broadcasts may be provided from other sources such as multiple transmitters provided in the affected area, mobile transmitters on vehicles of the authority, hand held transmitters, cellular or pager networks, or the like.

Other configurations of the present invention may include display and data entry buttons, battery powered or AC powered; without a display or data entry buttons and current time and date provided with an NIST signal; with a selectable watering schedules selection means such a dip switch to select even or odd street addresses, or watering groups, or any combination thereof. In the embodiment illustrated in FIG. 12, an internal drought stage selection means is provided. For example, if the SNWA has pre-set drought stages, all the drought stages may be incorporated within the device. This would eliminate the need for the SNWA to mail out data transfer devices for different stages of drought. Instead, the water authority would simply instruct the user to enable, for example, the stage 2 program incorporated within the module by either selecting the stage with front panel switch or programming, by flipping a dip switch 37 to select stage 2, etc.

Many “smart” controllers or smart add-on modules add the daily amount of water theoretically needed by the landscape vegetation root zone until a set threshold is reached. This is done to insure adequate root zone water penetration. When the threshold is reached, the controller is activated to open the valves and provide irrigation. However, the day or time that the irrigation threshold is reached may not be, and is frequently not, an allowed watering day. In such cases, the irrigation is omitted, and if subsequent threshold days fall several consecutive times on a non watering day, there may be an irrigation deficit detrimental to the landscape vegetation. Accordingly, several embodiments of the present invention include a feature of the module in the form of a display 34 or other indication that watering was attempted but prevented (skipped); in alternative embodiments, the feature may indicate the number of skipped watering attempts and/or the date or time of such attempt(s). The attempts at watering may be determined by the module which senses that the controller has come on, but because the output switch (e.g. common line) was open, no irrigation occurred.

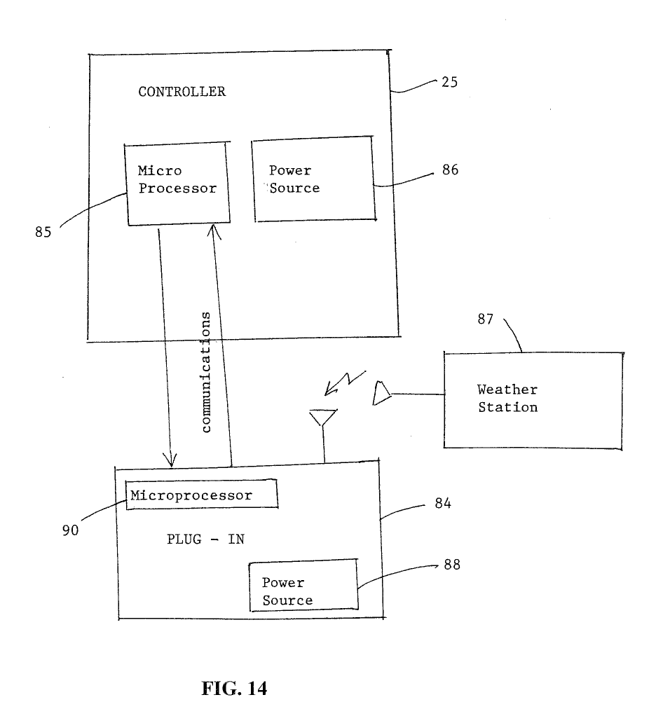

FIG. 14 illustrates a plug-in embodiment of the present invention. In this embodiment, a plug-in module 84 including a microprocessor 90 communicates directly with a microprocessor 85 in the controller by hard wired or wireless means. The module 84 is programmed with one or more restricted watering schedules. In some implementations, entering a zip code or street address or watering group can select the watering schedule appropriate for that location. The module may also provide smart watering technology to the controller through the same communication link. One or more municipally set watering restrictions of allowed or not allowed watering days or times of day, including any seasonal or periodic changes in those watering restrictions, are communicated from the module to the irrigation controller. Typically, a plug-in can only communicate with certain brands or models of irrigation controllers because they must be compatible with the controller microprocessor. The difference between a plug-in and an add-on is that the add-on is compatible with any irrigation controller because it is typically installed to break the common line during non-allowed watering times. Virtually every irrigation controller has a common line to the valves, whether they are AC, DC (battery powered), ambient light, or two wire systems. If the plug-in is smart (i.e., capable of making watering adjustments based on current or historical environmental data), one or more environmental sensors (illustrated generally as a “weather station” 87 in FIG. 14) can communicate by wired or wireless means to the plug-in module. The power source in the controller 86 and the power source in the plug-in 88 can be AC, DC, solar, battery, or ambient light.

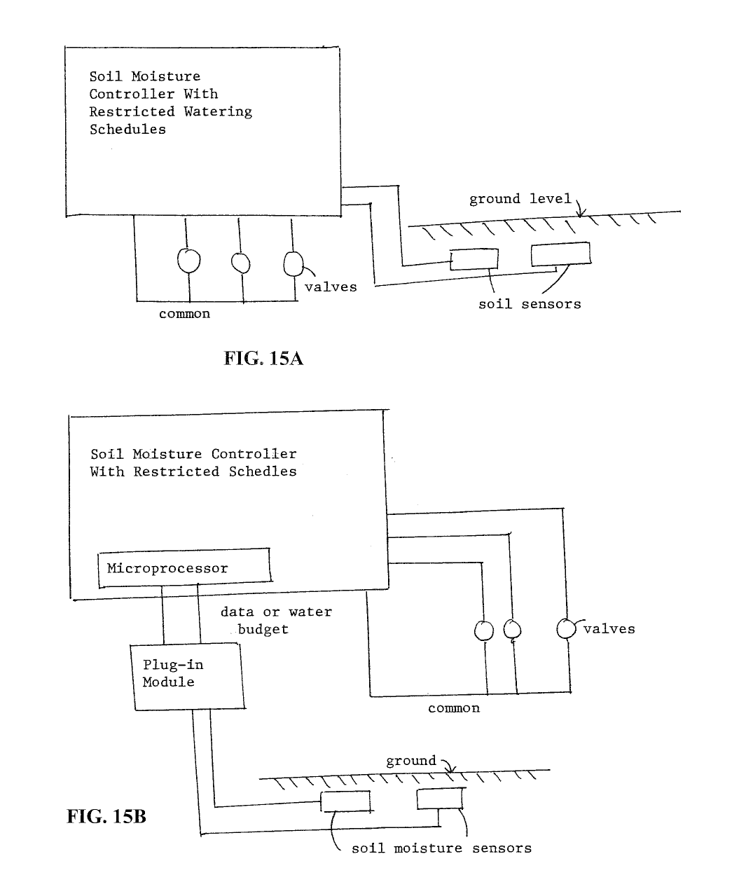

FIG. 15A illustrates an example of a soil moisture sensor based irrigation controller with restricted watering schedules. The controller receives field soil sensor data with which a preliminary (e g summer) irrigation schedule may be modified. The controller can then either accumulate the sensor data that is converted to a percentage of the summer run times and allow the irrigation cycle to execute when a soil moisture threshold and an allowed watering day is reached, or perform a daily water budget percentage irrigation to refill the root zone to some programmed level. The communication from the field can be by wired or wireless means.

FIG. 15B illustrates an example of an irrigation controller with restricted watering schedules with a plug in module. The module receives field soil moisture sensor data and provides the controller with the water budget percentage for proper irrigation to refill the root zone to a certain prescribed level with the appropriate percentage of irrigation based upon the summer irrigation schedule. If a non-watering day is present, the percentage of the summer run times continues to accumulate until an allowed watering day is reached. Once again, the data from the field moisture sensors can be provided by wired or wireless means.

Each of the following examples are for illustrative purposes only, and do not limit the scope of the appended claims.

### FIRST EXAMPLE OF AN APPLICATION

The SNWA watering schedule (FIG. 2) is used in this example. The SNWA divides Clark County, Nevada into six watering groups A-F. Escalating fines are levied for violations from these regulations. While these schedules are mandatory, it is not practical to effectively police the 500,000 addresses within the SNWA jurisdiction. The SNWA estimates that less than 30% make an effort to comply with these limitations. In this example, the present invention is provided in the form of a small add-on module 20 having a display 22, data entry means (one or more buttons, switches, etc.) 23, or a selectable switch 37 as shown in FIG. 1, an input wire from the common of any controller 31, and an output wire 32 to the common of the valves 30. It is preferred that module 20 be self powered and electrically isolated from controller 25 or from external power. This preferred embodiment makes module 20 electrically safe and immune from power and electrical surges. In addition, in this configuration, module 20 is easy to install and program. It is cost effective in terms of water conservation, and should eliminate fines due to violations of local watering schedule ordinances.

AC power from either the nearby controller (typical 24 volts AC) or from a 115 volt outlet may be used, but if so, the module 20 is no longer isolated and subject to failure due to primary power surges and may require professional electrical installation. That is one reason why a battery powered module isolated from AC powered is preferred.

By way of example only, and without limiting the scope of the appended claims, programming of module 20 may be provided that includes the watering schedules established by the SNWA for groups A-F. The user installs the module 20 on the common output line 19 from an existing controller, and then enters the current date and time, and selects the watering group (A-F in this example) for the particular location where the module is installed, using a switch 37 or data input or programming buttons 23. The module is programmed to conform to the watering restrictions for each of these six watering groups, so entry of a watering group will determine which program of watering restrictions the module 20 will use. During the summer, for example, from May 1-August 31, watering is permitted for any group any day of the week, but not between 11 a.m. and 7 p.m. (See FIG. 2.). During the spring and fall, groups can water any time of day, but only on Mondays, Wednesdays, and Fridays for groups A, C, and E. Groups B, D, and F can water on Tuesdays, Thursdays, and Saturdays. In alternative embodiments, the current calendar and time of day may be pre-programmed for the Clark County region governed by the SNWA, so only the watering group need be entered by the user.

Typically, every day is an allowed watering day during the summer in Clark County. Therefore, in this example, during the spring and fall, the allowed watering days will automatically conform with the summer watering days. During the winter, while there is only one watering day allowed, it will also coincide with the summer schedule since every day during the summer was a watering day. Of course, watering will not occur on the non-allowed days during winter, spring and fall. Therefore, no change in programming is required by the homeowner, or landscape maintenance contractor for commercial projects. In alternative embodiments, automatic adjustments for daylight saving time and leap year may be included in the internal clock to make it even easier for the residential and commercial users.

In preferred embodiments, module 20 is self-powered, so household power failures, or surges from power lines should not affect the module 20. Because these embodiments are also isolated from the field, no lightning or solenoid caused transients should affect the module either, further improving the reliability and longevity of the module. Embodiments using low DC power operation, pose little or no safety concerns. The module 20 is designed to be installed by the homeowner because it is so simple to install (two wires to connect), and embodiments are so easy to program (enter water group). In some embodiments, the module may be provided in an even simpler configuration without a display and pre-programmed according to its water group designation.

In alternative embodiments, during non-watering periods, an icon could show on the display 22 (if provided) indicating that this is a non-watering period. In alternative embodiments, an override or bypass function 55 could be provided for emergency watering, during new lawn plantings to allow for germination or establishment, or for other special purposes. Even though module 20 is designed to have its battery operate the electronics and cutoff switch for as long as 10 years, in alternative embodiments a battery status indicator function 39 could be provided to indicate the state of the internal battery. For user friendliness, the allowed watering days for the current time of the year for the watering group assigned to the user could be displayed. In this way, the user can easily see if today is an allowed watering day, and when the next watering day will occur.

The mandatory use of such modules could provide nearly 100% compliance to the SNWA watering restrictions and could save an estimated 10% of all its total annual water usage in Southern Nevada. In addition, it should drastically reduce and/or eliminate virtually all fines due to violations, including elimination of the policing and administration of fines. Furthermore, landscape maintenance contractors will not have to return four additional times a year to each controller just to adjust for the seasonal programming changes; and homeowners can install the modules and not give them another thought for years on end.

Alternately, instead of using an add-on module to existing controllers, as shown and described in FIG. 8, the SNWA watering restrictions can be pre-programmed into the controller, smart or conventional, downloaded, uploaded, or manually programmed into the controller with the data input means of the existing controller as described in the FIG. 8 discussion. The controller then automatically adjusts its watering according to the restrictions that have been input, and re-adjusts as different restrictions become applicable at different times of the year.

While the SNWA program has been selected as an example, the same principle applies to other communities with mandatory governmental watering restrictions such as, for example, even or odd address groupings along with seasonal changes. A relatively simple change in software is all that is necessary to accommodate any community's or region's specific watering restrictions.

### SECOND EXAMPLE OF AN APPLICATION

In alternate embodiments, the modules 20 of the present invention may be provided pre-programmed with the mandated irrigation schedule for a particular community without a display or data entry buttons, as shown in FIG. 6. In these embodiments, the government mandated watering schedule for only one particular group is pre-programmed into the module 20, along with the time of day and calendar date, preferably including programming for daylight savings time and leap year. All modules containing the pre-programming for the particular group are given the same distinguishing characteristic (e.g., same size, shape, color, etc.). This allows these modules to be identified as corresponding to a particular watering group, or containing a particular set of pre-programmed instructions or watering schedule. Modules having different programming are given a different identification characteristic. Thus, for example, all modules that are red in color may be pre-programmed for watering group A; all modules that are blue in color may be pre-programmed for watering group B, etc. It is then simply a matter of providing each use with correct module for the user's location to implement the correct watering restrictions at that location. It is to be appreciated that different characteristics or combinations of characteristics may be used to identify different programming in the module. For example, modules that are red in color may contain schedule A, blue in color contain schedule B, and modules that are square in shape may be used for even-numbered addresses, with modules that are round in shape for odd-numbered addresses. Thus, there may be modules that are both red in color and round in shape (schedule A for odd-numbered addresses), and modules that are red in color and square in shape (schedule A for even-numbered addresses). Multiple combinations of characteristics are contemplated in these embodiments of the invention.

In these embodiment, there is no programming required by the user. The water district provides a module with particular characteristics (e.g. blue, round, etc.) to the customers based upon the customer group or even/odd address, or other factor(s). The module contains the appropriate pre-programmed watering schedule(s) for that user's location. In some embodiments, a display may be provided which shows the pre-programmed time of day and date which can be adjusted by the user, or this information may be pre-programmed and not be adjustable by the user (with no need for data input or display). In alternative embodiments, the modules can be provided with the capability to receive the time of day and/or calendar signal from NIST. With current energy management technology and low power microprocessors, the internal battery may be of adequate capacity to operate the module for its effective life without need to change batteries. A override or bypass feature may be provided as an option for the convenience of the user for special situations when the watering schedule is not to be followed, such as new plantings or maintenance purposes.

In alternative embodiments, the modules may be pre-programmed with all of the possible watering schedules mandated by the local governmental authority (and/or additional watering schedules to allow for future changes in those restrictions). In these embodiments, it is possible to select a watering schedule by using a switch, button or other selection means 37 on the module 20. (See FIGS. 1A, 1B and 1C). For example, and without limitation, a switch 37 on the module may be provided with six different positions, A-F, corresponding to the six watering groups of SNWA as shown in FIG. 1C. The user moves the switch to select the appropriate group (e.g. move the switch to “B”), and the module implements the pre-programmed watering restrictions of that group. It is to be appreciated that additional selections (and switch positions) may also be provided for unusual, emergency, maintenance or other situations. For example, the user's normal schedule (e.g. “B”) may call for 5 days a week watering during the summer, but if a drought occurs, the local watering authority may allow only 3 days a week of landscape irrigation. This may be pre-programmed into the module, and the homeowner may simply select this program by moving switch 37 to a setting such as “Drought-B3” for 3-day watering during drought conditions in group B. It may be as simple as flipping a dip switch within the device to select the new drought plan being implemented. It is to be appreciated that multiple combinations of alternative schedules may be pre-programmed into the module, with corresponding switch settings to select them. In some embodiments, the switch setting may allow single or multiple sets of pre-programming to be selected (e.g. “Even-Drought-B” or “Odd-Drought-B”, and the like). In other embodiments, the pre-programming for only a single group (as with the color-coded modules described previously) may be provided, plus a variety of alternative selections such as emergency, maintenance, etc.

### THIRD EXAMPLE OF AN APPLICATION

By way of example only, and without limiting the scope of the appended claims, the customers of the local water agency are provided with a water scheduling module of the present invention. However, because of the persistence of a drought, or in combination of the draught and rapidly expanding demand upon the pumping and delivery capacity of the locale, the water district requires stricter watering schedules that are not already pre-programmed into the modules. For example, the SNWA area, instead of restricting watering from 11 a.m. to 7 p.m. during the summer, this may be changed to 10 a.m. to 8 p.m. Or, instead of allowing watering seven days a week from May 1 to August 31, the summer season may be changed from June 1 to September 15. Or the SNWA may determine that Sundays are no longer be an allowed watering day during the summer. (The Irrigation Association recommends deficit irrigation practice during drought years. It is recommended that up to a 20% deficit in irrigation is acceptable and not permanently detrimental to landscape vegetation. Following this guideline 1/7^{th} reduction in irrigation during the summer in Clark County, for example, would be acceptable practice and would correspondingly save a significant amount of landscape irrigation water.) It would be difficult for homeowners to manually comply with these types of changes if they are not already pre-programmed into the modules, and providing a new set of modules could be prohibitively expensive and time consuming

Should SNWA or any water district or authority wish to change the watering schedules for any reason (newly implemented schedules, changing draught conditions, additional stress upon the infrastructure, etc.), instead of replacing the modules 20 of the present invention, updates can be provided to embodiments of modules 20 of the present invention in a variety of different ways. In some of these embodiments, a small data storage device 36 is provided that contains the new or updated local water restrictions. Any suitable small data storage devices 36 may also be used, such as magnetic cards or strips, USB flash drives, etc. In some embodiments, the dimensions of this device 36 may be, for example, as small as about ½ inch square by 0.1 inch thick. The small data storage device 36 contains the new watering time of use schedules. It is preferably be small enough to be mailed by the water authority with the water bill in an envelope. Upon receipt, the user causes these embodiments of module 20 to read the data on the device 36, for example, by plugging the device 36 into the module 20 and then pressing an “enter” button, swiping device 36 through a reader on the module, etc. The revised schedule could then be immediately implemented throughout the local water district at little or no appreciable cost.

These embodiments of the present invention make it easier to implement new watering schedules without replacing the module, and avoid asking the homeowner to (a) remove the module, (b) take it to their computer, (c) attach a cable to the module in order to (e) download the new schedule, and then (e) remount the module. An even less desirable method of programming is to ask the homeowner to remove the device and take it in to a reprogramming location. Not only is this not convenient, many users may not comply with the watering restrictions if they have to remove the unit from their residence. Of course, as previously discussed, the new watering schedules may be entered into the module in the same way as into the controller.

It is to be appreciated that other embodiments of the invention, such as those in which the module contains a wireless receiver as discussed more fully below, may also be used in this example. However, wireless embodiments would add some cost to each module. However, while the module itself adds cost, the method of updating the module by wireless means may save time and virtually the entire cost of the data transfer device, and its mailing. It also makes the upgrading virtually instantaneous and not dependent upon the homeowner's performance, as simple as it may be. Each water district would need to weigh chances of requiring frequent upgrades versus a one time expense of a somewhat higher module cost and a broadcasting capability. The size of the water district and the possibility or probability or future upgrades would determine the method chosen by a community, water district, or governmental irrigation regulating agency, requiring each one to have a receiver that is continuously monitoring for the signal, which would require additional power. Other embodiments provide a connector or jack 27 on the module 20 into which a cable is inserted to download updated programming. The new programming may be provided via cable from any of a number of sources including the Internet, a local computer, a mobile hand-held device, or the like.

Conforming to restricted watering schedules not only conserves water, but also preserves the water delivery capabilities of most communities, saving considerable infrastructure cost upgrading to meet increasing populations, particularly in the western states. However, despite ET theory studies for the last 50 years, education by the EPA, Bureau of Water Reclamation, California Department of Water Resources, western water agencies, the Irrigation Association, and the Irrigation Center for Water Technology, and rebate enticements to convert to ET or weather based systems to conserve water, effective water conservation has not been achieved. A realistic goal of 60% compliance to restricted watering schedules using the present invention would be 600 times more effective than the 0.1% voluntary compliance to date with existing smart methods in terms of real water conservation.

### FOURTH EXAMPLE OF AN APPLICATION

By way of example only, and without limiting the scope of the appended claims, in alternative embodiments, very simple and inexpensive versions of module 20 of the present are provided. As with other embodiments, the module 20 is attached to the output of any existing irrigation controller along the common line. In these simple embodiments, the module 20 has no display, no data entry buttons, and does not need time of day and date. In these embodiments, module 20 does not even need a (relatively expensive) power supply. A small lithium battery may be provided to operate the microprocessor and a double EPROM may keep the programmed watering schedules. The module may draw the majority of its power from either the existing irrigation controller low voltage (typically 24 VAC supply) and internally convert it to usable DC voltage to operate a built in radio receiver 41, electronics, and common line switching means.

In the simplest of these embodiments, a centrally placed transmitter operated by the local community or water agency wirelessly transmits an ON or OFF signal. The transmission may be by any suitable wireless means such as, without limitation, cellular, pager, radio, microwave or the like. Every module 20 in the local receiving area would be monitoring for this signal. When the local watering restrictions prohibit watering (e.g. 11:00 a.m.-6:00 p.m. every day), the “off” signal is sent, and all modules respond by braking the common line of the controller to which they are associated, preventing irrigation from taking place. When watering is allowed (e.g. after 6:00 p.m.) an “on” signal is then sent. No time of day or calendar is required within the device since the central location would keep that time, and the device is merely an ON or OFF module with a wireless receiver. FIG. 13 shows the general concept of these embodiments. These embodiments may also be used, for example, in case sufficient precipitation has fallen in the area, an “off” command may be transmitted to the entire community to disables all irrigation. With these “on/off” signals, no existing controller outfitted with the device can irrigate at prohibited times, since the common line to all the controller's valves will be cut off.

The next level of sophistication using these embodiments allows each module to be independently addressable. In these embodiments, each module has in internal address which is provided in the broadcast along with the ON or OFF command The “on” and “off” commands could be provided in such a way that all modules are directed to respond to them, or they may be addressed to groups of modules or individual modules, as desired. For example, and without limitation, each remote module could be addressed with an even or odd address, or watering group, or the like, which then recognizes the central signal as being specific to itself, thereby controlling the ON or OFF output command differently depending on its address or watering group.

The cost and complexity of these embodiments of the module of the present invention is reduced even further by the elimination of a display and data entry buttons, elimination of a sophisticated microprocessor. Very simple embodiments of the module of the present invention include only an addressable receiver and an on/off switch to break the common line from the controller, the module accessing power from the controller itself. Such embodiments would be completely controlled by broadcasts from the water authority. One significant advantage to the local water district is that the watering schedules may be instantly modified as the water supply and infrastructure allow, without having to manually re-program the modules. Current wireless technology is such that city-wide wireless data and command communications is not uncommon, relatively inexpensive, and reliable compared to the additional cost of paying for the additional complexity of microprocessors, programming, displays, data storage, etc.

### FIFTH EXAMPLE OF AN APPLICATION

Instead of mounting a module 20 of the present invention at the controller, it could be mounted adjacent to a master valve for convenience. These embodiments only work with irrigation systems having a master valve 35 upstream of all slave valves 30 in the system that must be opened before water reaches the slave valves. See FIG. 6. In these embodiments, the module is installed on the electrical line to the master valve 35, and performs the same function as breaking the common wire to the slave valves 30, but instead breaks the line to the master valve 35. This method hydraulically disables the slave irrigation valves.

In alternative embodiments where a master valve 35 has been implemented with slave valves 30 in FIG. 7, and the default position of the master valve 35 may be open. In these cases, instead of the module 20 of the present invention breaking the common line when a non-watering time arrives, it sends a pulse to the solenoid on master valve 35 to close the valve. When a watering-allowed time arrives, another pulse is sent to the solenoid to re-open master valve 35.

It is to be noted that FIGS. 6 and 7 concern the use of a master valve, which is more common in commercial rather than residential use. The difference between these embodiments is that in FIG. 6, the module of this invention is in the electrical common line between the controller and the master valve, while in FIG. 7, the module operates to hydraulically close or open the master valve without breaking the common line. The module in this embodiment is mounted directly on the master valve and a latching solenoid powered by the module opens or closes the valve. The watering restrictions are still programmed within the module as before, and either a display can be programmed with the time and date, or an NIST time signal can perform this function. In the case of FIG. 7, the module would almost certainly be battery powered and may be mounted inside a valve box, if desired.

### SIXTH EXAMPLE OF AN APPLICATION

In this example, the “big” picture is considered. One or more water reservoirs (dam, lake, aquifer, or the like) are used to store a local community's water supply. The water is used for agricultural, commercial, and domestic needs. With respect to domestic usage, landscape water use that accounts for over 50% of that usage. Certain times of the day account for peak water demand such as early morning when showers are taken, breakfast is cooked, or toilets are flushed, or clothes are washed. This would account for a relatively high water demand for domestic use between the hours of 6:00 a.m. and 8:00 a.m. It would therefore be desirable that landscape irrigation not occur during those hours in order to not increase the water pumping and delivery demand. There may also be multiple peak water demand times that place excessive burdens upon the pumping and delivery system. Higher water demand may require additional pumps to go on line, which would increase the power to deliver that higher demand. Consequently, by preventing landscape irrigation during peak hours, the pumping and delivery demands are eased, and adequate water pressure is more easily maintained, which improves irrigation efficiency by supplying a relatively stable and adequate water pressure. In addition, by limiting the watering days to certain days of the week, during certain times of the year, landscape water usage is automatically reduced. The result is better irrigation efficiency, which saves water, less irrigation, which saves additional water, and less pumping demand which saves energy and the need to add additional pumping and delivery capabilities, which saves significant infrastructure upgrading costs.

In this example, modules with wireless receiving capability allow for instant program updating or shut down of irrigation systems in case of rain or cold temperatures.

In embodiments that require no external device or special programming, each irrigation controller may be provided with a receiver and software capable of receiving a broadcast signal designating whether or not irrigation can take place. In addition to controlling peak time watering activity, if it is raining, for example, each remote controller can be instructed to not irrigate for a period of time. If the temperature falls below a certain level, near freezing, for safety reasons, the controllers may be ordered to suspend irrigation until the temperature reaches above a certain level. For water conservation, only certain watering days may be permitted depending upon the season. For infrastructure capability reasons, watering may be limited or prohibited during certain times of the day. In the less expensive case, an add-on module is preferred, the module instead of the controller has wireless receiving capability that is attached to the output of any irrigation controller that will allow or not allow irrigation as previously described. The advantage of this method is that the module can work with any brand of controller, and with any number of stations. In addition, the homeowner does not need to learn to program a new controller. Another advantage is that the water district may consider providing the module free of charge to the customers if it is at reasonable cost. This wireless method would also allow changes to the watering rules to be immediately provided to the customer's irrigation system.

### SEVENTH EXAMPLE OF AN APPLICATION

It is conceivable that a water district may want to upgrade the watering schedules by means of hand held wireless transmitters, or broadcasting the new water schedules by mobile means mounted on a driven vehicle which broadcasts the new watering restrictions area by area, or community wide. In a certain rapidly expanding area, for example, the water district may wish to alter the certain watering schedules without affecting the entire district. In these situations, the module 20 would be outfitted with a receiver that can accept the new program as the water district truck drives by the neighborhood. Only the modules with certain addresses or identity codes would be affected. This is an alternative to a general drought plan upgrade that may affect the entire region.

In other embodiments, the modules 20 may be outfitted with data ports or connector jacks into which a cable may be plugged. The user may then download updated watering restrictions via cable inserted into the connector from a variety of possible sources as directed by the local water authority, including without limitation, downloading from the Internet, a local computer, a hand-held device (brought to the module by a service person for the water authority), at a designated location established by the district for downloading of updated programming, or otherwise.

### EIGHTH EXAMPLE OF AN APPLICATION

In a simple and low cost form, an embodiment of the module of the present invention may be provided with no display or data entry switches or buttons. In these embodiments, the time of day and calendar, daylight saving time, and leap year may be internally controlled with an accurate oscillator and real time clock. The watering schedule for a given watering group is pre-programmed into a set of modules 20, and each module in that set is color coded (or given some other unique characteristic) for identification with that particular watering group. Other modules with a different pre-programmed watering schedule are given a different characteristic (color). The modules of these embodiments are self-battery powered to last for at least 10 years (the effective life of the module), or from power from the controller with an internal small lithium battery to keep time in case of power failure. The modules are provided to each user containing the pre-programmed schedule for their address or location. In alternative embodiments, a simple indicator such as an LED light can indicate whether this is a watering day or not, and/or an external push button 55 can provide the bypass function, and/or a visual signal 34 may be provided to indicate that watering was attempted during disabling of the valves. Module of these embodiments attach with two wires to break the common from the controller to the valve(s). These modules automatically regulate the irrigation watering cycles.

### NINTH EXAMPLE OF AN APPLICATION

In these embodiments, the local water district or governmental agency has already provided their users with a form of the module of this invention. However, the agency determines that a change to the watering restrictions is needed in one or more parts of the community due to rapidly expanding housing. In this example, each module is equipped with a receiver that is monitoring for a signal. If AC power is continuously provided from either the controller or a 115 VAC outlet near the module, the receiver can continuously monitor for a wireless signal. In one scenario, a remote vehicle equipped with a transmitter can travel through the neighborhoods in question and wirelessly reprogram the local modules with the new watering restrictions without the need to access the module which is typically placed near the controller, which is frequently located in the garage. Using this method, selective reprogramming can be accomplished if each module is electronically addressed to respond to the new watering restrictions. In another scenario, as shown in FIG. 13, a central broadcast can selectively or globally reprogram all the modules with the new watering restrictions.

### TENTH EXAMPLE OF AN APPLICATION

In this example, one or more restricted watering schedules are programmed into an existing controller which may be conventional or smart, AC, DC, solar, or ambient light powered. The schedules may be programmed into the controller at the factory, downloaded, uploaded, or manually input. Assuming the controller already has smart water technology, the restricted watering schedule of allowed watering days or times of the day are also programmed into the unit. The controller screen with regard to watering restrictions at a particular location could appear as follows:

Season dates: Summer: May 1-August 31
Fall: September 1-October 31
Winter: November 1-End of February
Spring: March 1-April 30

Watering group: Even addresses (or odd, watering group, etc. . . . )

Seasonal allowed watering days:
Summer: All groups, every day except Sundays, not between 8 am and 8 pm
Fall and Spring: Even group on Mondays, Wednesday, Fridays
   Odd groups: Tuesdays, Thursdays, Saturdays
Winter: Even groups: Wednesdays only

In this example, depending upon the watering group designated, watering can be done on different days depending upon the season of the year. No watering is allowed on Sundays, and watering is not allowed year round between 8 am and 8 pm. In this example, the controller is programmed to automatically change the allowed watering days as the prescribed seasons change, not necessarily coinciding with the calendar season, depending upon the geographic location and the date and time.

In this example, if the watering restrictions were not automated, the user would need to reprogram his controller at least 4 times a year or face watering violations or fines. The present invention provides automation to the restricted watering schedules, a feature that can be provided in residential or commercial controllers, AC, DC (battery) or solar powered, with smart water technology, or conventional. The same approach can be provided with either an add-on that breaks the common line as previously discussed, or as a plug-in that communicates the water restrictions program directly to the existing controller through an input port.

The automated watering restrictions program can be either manually entered into the controller, add-on or plug-in, or wirelessly transmitted through a YFI computer generated program, or downloaded with the use of a memory stick or through a USB connection. The critical result is that the watering restrictions are automatically varied throughout the year without the need for manual adjustment.

### ELEVENTH EXAMPLE OF AN APPLICATION

In this example, a plug-in module (such as that shown in FIG. 14) is plugged into an irrigation controller. The controller may be smart or conventional, but does not have the automated restricted watering schedule capability. The plug-in will typically only work with certain models or brands of controllers because it requires a microprocessor as well as a communication link to the controller microprocessor. Therefore, the plug-in microprocessor needs to be in compatible communication with the controller microprocessor. One or more restricted watering schedules may be programmed or pre-programmed into the module. In this example several schedules are pre-programmed, such as the SNWA, the Los Angeles Water District, East Bay Mud, etc. Entering the zip code into the plug-in determines the location of the plug-in, and the schedule(s) to be used. In this example, that location is in the SNWA area. Next, the plug-in is programmed with the watering group assigned to that water district by the user (which may be established by street address, etc.). After having selected the water district, and entered the watering group, the plug-in determines the allowed (or not allowed) watering times for that selected watering group and that municipal water restriction schedule. This information is then then automatically implemented and communicated to the controller. The controller then automatically varies its irrigation according to the program communicated to its microprocessor, seasonally or periodically varying the allowed watering days and times of day depending upon the date. It is to be appreciated that the plug-in module keeps track of the date such that when a different set of watering restrictions becomes applicable (e.g., change over from summer to fall restrictions on October 1), the plug-in automatically communicates the fall watering restrictions to the controller which are then implemented. The plug-in may automatically select the applicable SNWA seasonal calendar as shown in FIG. 2 which is then automatically implemented and communicated to the controller.

In other embodiments of plug-ins, environmental data may be provided to the plug-in from a sensor, such as the weather station shown in FIG. 14 (item 87). This can provide data from which smart calculations may be made and communicated to the controller, and/or basic precipitation data can be received by the plug-in which directs the controller to shut down irrigation during rainy periods. A freeze sensor can also provide a shut down signal to the module which is communicated to the controller.

### TWELFTH EXAMPLE OF AN APPLICATION

In this example, a smart irrigation controller, add-on or plug-in is augmented with watering restrictions which vary seasonally. For its smart technology, the controller, add-on or plug-in already has a data base with location identifying data (such as zip code). To implement and automate municipally mandated watering restrictions, the following steps would typically be followed:
1. A number of schedules of municipally mandated watering restrictions (for different locations where the module could be deployed) are stored into the irrigation controller, add-on or plug-in microprocessor.
2. Data is entered (such as zip code) to identify the location, which in turn determines the watering restrictions applicable for that community, municipality, or water district.
3. If those restrictions vary seasonally or periodically, those parameters along with their effective dates are selected. It is to be appreciated that in some cases a single (annual) schedule may include multiple (seasonal) sub-schedules.
4. If smart technology alone is selected, the microprocessor processes the environmental data and irrigates based upon ET, soil moisture, or any other form of smart technology such as this inventor's temperature budgeting method.
5. If watering restrictions are in effect and are enabled in the devices, the smart device attempts to irrigate according to the smart water calculations, but is prevented from doing so until an allowed watering day or time of day is reached.
6. During the course of the year, if the restricted schedules vary to account for seasonal changes, the allowed watering times automatically change and the smart irrigation is implemented accordingly.
7. If only watering restrictions are prescribed at that location and the smart technology is disabled, the controller operates according to the selected schedule of allowed watering times which may vary seasonally or periodically as described in other embodiments.

### CONCLUSION

Depending upon location, water supply and infrastructure conditions, some municipalities may choose to require smart controllers (such as in California after January 2012, tentatively). Some areas have an adequate water supply but inadequate pumping or water delivery capability. These areas would decrease the pumping load by dividing the time or days of water demand by instituting watering restrictions by even or odd address, watering groups, or the like. Some areas may have both a shortage of water supply and an infrastructure inadequacy. In such cases, there is a need to both save water and decrease the water load demand. In addition, in some locations, it may be desirable to vary the water load further seasonally by requiring seasonal or periodic changes in their watering restrictions. No simple, inexpensive automated solution has been offered to date to accommodate these needs.

Embodiments of the present invention provide solutions for many conditions affected by water availability and infrastructure needs by providing automated and selectable watering restrictions that can be automatically varied seasonally, and by augmenting smart technology in new controllers with such automated and selectable watering restrictions. For existing non smart controllers, add-on modules and plug-ins can provide smart technology as well as automated watering restrictions. Automation of watering restrictions allows for seasonal or periodic changes without the need for manual reprogramming of the irrigation controllers, add-ons or plug-ins to controllers. This automation can be wirelessly transmitted to the controllers, plug-ins or add-ons, or directly programmed into them. Automated water restrictions is also convenient to the user and eliminates fines, while potentially saving more water than smart water technology and the high cost of infrastructure upgrading.

Controllers of the present invention may be programmed to receive one or more restricted watering schedules, and automatically select and implement the appropriate schedule according to the current date and time and location. In the case of existing controllers (whether “smart” or not), an add-on module can still be attached to break the common line and perform its watering schedules in addition to the controller's smart functions, if present.

Embodiments of the present invention are universal in limiting watering to specific watering schedules, and can be used with or be made part of, added onto, plugged into or wirelessly communicate to an AC or DC controller, conventional or smart, with any number of stations, in residential, commercial, or turf applications. Embodiments may be self-powered for convenience, surge isolation, and safety. Embodiments are extremely simple to program and install, very cost effective, and will save more real water. In addition, embodiments will reduce or eliminate the policing and fining of violators, as well as visits by maintenance contractors simply to change irrigation programming as mandated by the water authority for the particular season of the year.

Finally, it is most important to note that one of the primary advantages of the present invention is automatic implementation of government mandated watering schedules. In the past, reducing water consumption has been accomplished by relying on the user to manually make changes (such as re-setting a thermostat), water infrastructure improvements postponement has been done with manual reprogramming of existing controllers, and smart controllers have to be manually programmed with data entry of existing landscape conditions often being dependent on available ET data (transmitted or by adjacent weather station). In contrast, embodiments of the present invention provide an automated watering schedule governor that requires little or no setup by the user (other than perhaps entry of even/odd, or selecting a watering group), automatically enforcing watering restrictions instead of relying on homeowners or commercial users for manual compliance.

It is to be appreciated that different versions of the invention may be made from different combinations of the various features described above. In addition, any of the features of any of the embodiments disclosed herein may also be incorporated into other embodiments, or adapted for use with master valves. It is to be understood that other variations and modifications of the present invention may be made without departing from the scope thereof. It is also to be understood that the present invention is not to be limited by the specific embodiments or any of the examples disclosed herein, but only in accordance with the appended claims when read in light of the foregoing specification.

What is claimed is:

1. A method of automatically regulating the times that irrigation is allowed by an irrigation controller operating at least one valve comprising the steps of:
a. said controller with a schedule of allowed watering times established by a government authority; and
b. Said controller enabling said valves to allow irrigation at times when allowed by said schedule.

2. The method of claim 1 comprising the additional step of periodically varying said schedule of allowed watering times.

3. The method of claim 1 comprising the additional step of seasonally varying said schedule of allowed watering times.

4. The method of claim 1 wherein an environmental sensor is provided, and comprising the additional step of disabling said valves based upon current input from said environmental sensor.

5. The method of claim 4 wherein said environmental sensor is selected from the group consisting of: soil, precipitation, temperature, humidity, wind or combinations thereof.

6. The method of claim 1 wherein a plurality of schedules of allowed watering times are programmed into said controller, and said method further comprises the step of selecting one of said schedules.

7. The method of claim 1 wherein said controller further comprises programming for smart watering, and said method further comprises the step of adjusting periodic watering according to said smart programming.

8. An irrigation system comprising:
a. An irrigation controller with a power supply and a microprocessor;
b. At least one schedule of not allowed watering times provided to said microprocessor;
c. At least one output from said controller in communication with at least one valve;
d. Said microprocessor having programming that is capable of automatically preventing output to said valves when irrigation is not allowed according to said schedule.

9. The system of claim 8 further comprising a plurality of schedules of not allowed watering times wherein said microprocessor has programming to automatically select and implement one of said schedules according to date and time.

10. The system of claim 8 wherein the programming in said microprocessor is capable of periodically varying said schedule of not allowed watering times.

11. The system of claim 8 wherein the programming in said microprocessor is capable of seasonally varying said schedule of not allowed watering times.

12. The system of claim 8 wherein said power supply is selected from the group consisting of: AC, DC, battery, solar, or ambient light powered.

13. The system of claim 8 wherein said at least one schedule is provided by one of the group of: manual entry, wireless transmission, pre-programming, internet download, USB computer connection, or memory stick.

14. The system of claim 8 wherein said controller further comprises programming for smart watering.

15. The system of claim 8 further comprising an environmental sensor in communication with said microprocessor, wherein said microprocessor has programming to prevent irrigation based upon input from said sensor.

16. The method of claim 15 wherein said environmental sensor is selected from the group consisting of: soil, precipitation, temperature, humidity, wind or combinations thereof.

17. An irrigation system comprising:
a. An irrigation controller including a microprocessor;
b. A separate plug-in module in communication with said microprocessor;
c. Said plug-in module having its own microprocessor capable of accepting at least one schedule of municipally restricted watering times;
d. Said plug-in module being capable of causing said controller to prevent irrigation when not allowed according to said at least one restricted schedule.

18. The system of claim 17 further comprising a plurality of schedules of municipally restricted watering times wherein said plug-in microprocessor has programming to automatically select and implement one of said schedules according to date and time.

19. The system of claim 17 wherein the programming in said plug-in microprocessor is capable of periodically varying said schedule of not allowed watering times.

20. The system of claim 17 wherein the programming in said plug-in microprocessor is capable of seasonally varying said schedule of not allowed watering times.

21. The system of claim 17 wherein said module communicates by wired or wireless means.

22. The system of claim 17 wherein said controller microprocessor further comprises programming for smart watering.

23. The system of claim 17 further comprising at least one environmental sensor in communication with said plug-in microprocessor, wherein said plug-in microprocessor has programming to prevent irrigation based upon input from said sensor.

24. The method of claim 23 wherein said environmental sensor is selected from the group consisting of: soil, precipitation, temperature, humidity, wind or combinations thereof.

25. An irrigation system comprising:
a. At least one irrigation controller, each controller having a power supply, a microprocessor, and at least one associated valve;
b. A remotely located central broadcasting unit capable of communicating with said at least one controller;
c. Said central broadcasting unit being capable of accepting at least one schedule of allowed watering times provided by a government authority;
d. Said broadcasting unit broadcasting to said at least one controller whether watering is allowed or not allowed according to said at least one schedule of allowed watering times;
e. Said at least one controller preventing irrigation when not allowed, and allowing irrigation when allowed, according to said broadcast.

26. The system of claim 25 wherein said power supply is selected from the group consisting of: AC, DC, battery, solar, or ambient light powered.

27. The system of claim 25 wherein said broadcasting unit further comprises programming for smart watering.

28. The system of claim 25 wherein said at least one controller further comprises programming for smart watering.

29. The system of claim 25 further comprising at least one environmental sensor.

30. The method of claim 29 wherein said environmental sensor is selected from the group consisting of: soil, precipitation, temperature, humidity, wind or combinations thereof.

31. A method of automatically regulating the times that irrigation is provided by a controller comprising the steps of:
a. providing programming in the controller for disabling power to its associated at least one valve;
b. providing the controller with a schedule of restricted watering times established by a government authority; and
c. said programming automatically disabling power to said at least one valve at times when watering is not allowed according to said restricted schedule.

32. The method of claim 31 wherein a plurality of schedules of not allowed watering times established by a government authority are programmed into said controller, and said method further comprises the step of selecting one of said schedules.

33. The method of claim 31 wherein said controller is provided with an input for receiving updated restricted watering times.

34. The method of claim 31 wherein said controller is powered by one of the group consisting of AC, DC, solar, ambient light, and combinations thereof.

35. The method of claim 31 wherein an environmental sensor is provided, and comprising the additional step of disabling said at least one valve based upon current input from said environmental sensor.

36. The method of claim 35 wherein said environmental sensor is selected from the group consisting of: soil, precipitation, temperature, humidity, wind or combinations thereof.

37. An irrigation controller for automatically regulating output to comply with local watering schedules comprising:
a. a power supply;
b. a microprocessor capable of receiving a local restricted watering schedule of a government authority; and
c. at least one switch for disabling power to at least one valve connected to said controller.

38. An apparatus for automatically regulating the output of an irrigation controller to at least one valve to comply with local watering schedules comprising:
a. a module internal to said controller comprising a microprocessor in communication with an internal switch for disabling power to said at least one valve, said microprocessor capable of receiving a plurality of schedules of allowed watering times established by a government authority, and programming to automatically activate said internal switch at times when watering is not allowed according to said schedules; and
b. a means for selecting one of said plurality of schedules.

39. A method for governing allowed irrigation watering times comprising the steps of:
a. programming a controller with local watering restrictions from a government authority; and
b. said controller automatically disabling an output to at least one irrigation valve in compliance with said watering restrictions.

40. A method of providing watering restrictions from a first location to at least one landscape irrigation controller at a second location comprising the steps of:
a. providing a wireless receiver to said at least one controller;
b. wirelessly transmitting watering restrictions from said first location to said receiver; and
c. said at least one controller regulating output to at least one valve based upon said watering restrictions.

41. An apparatus for regulating the output of an irrigation controller to at least one valve to comply with local watering schedules comprising a microprocessor inside said controller in communication with an internal cutoff switch, a receiver in communication with said microprocessor for wirelessly receiving at least one schedule of allowed watering times established by a government authority, and programming in said microprocessor to activate said internal switch at times when watering is not allowed according to said schedule.

42. An apparatus for regulating the output of an irrigation controller to at least one valve to comply with local restricted watering schedules comprising a receiver in said controller in communication with an internal microprocessor for wirelessly receiving said restricted watering schedules, and programming in said microprocessor to disable watering when watering is not allowed according to said local watering schedules.

43. A method of implementing watering restrictions established by a government authority comprising the steps of:
a. programming a plurality of controllers with said watering restrictions;
b. providing said controllers to persons located within a geographic area where such restrictions apply;
c. installing said controllers and connecting them to at least one valve; and
d. said controllers automatically disabling said at least one valve at times when watering is not allowed according to said restrictions.

44. A module for automatically regulating the output of an irrigation controller to comply with local watering schedules comprising:
a. a power supply;
b. a microprocessor capable of receiving a local watering schedule of a government-authority; and
c. at least one output cutoff switch located on an output line between said controller and at least one valve.

45. An apparatus for automatically regulating the output of an irrigation controller to at least one valve to comply with local watering schedules comprising:
a. a module comprising a microprocessor in communication with a cutoff switch, said microprocessor capable of receiving a plurality of schedules of allowed watering times established by a government authority and containing programming to automatically activate said cutoff switch at times when watering is not allowed according to said schedules;
b. a first electrical line for connection between said cutoff switch and a common electrical output of said controller;
c. a second electrical line for connection between said cutoff switch and a common electrical line leading to said at least one valve; and
d. a means for selecting one of said plurality of schedules.

46. An apparatus for automatically regulating the output of an irrigation controller to comply with local watering schedules comprising:
a. a module that may be plugged into an existing controller;
b. a microprocessor in said module, said microprocessor having programming that is capable of receiving a schedule of watering restrictions and communicating with said controller.

47. The apparatus of claim 46 wherein said controller comprises programming for receiving said restricted watering schedule from said plug in module, and for preventing watering when not allowed according to said restricted schedule.

48. The apparatus of claim 46 wherein the programming in said module is further capable of selecting an applicable schedule of watering restrictions based on time of year.

49. The apparatus of claim 46 wherein the programming in said module is further capable of causing said controller to stop irrigation.

50. An apparatus for automatically regulating the output of an irrigation controller to at least one valve to comply with local watering restrictions comprising a module that may be plugged into an existing controller, said module comprising a microprocessor having programming that is capable of receiving a plurality of schedules of allowed watering times established by a government authority, selecting one of said schedules that is applicable based on current date and time, and communicating said schedule to said controller.

51. The apparatus of claim 50 wherein said controller comprises programming for receiving said restricted watering schedule from said plug in module, and for preventing watering when not allowed according to said restricted schedule.

52. An irrigation system comprising:
a. at least one irrigation controller, each such controller having a power supply, a microprocessor, and at least one associated valve;
b. at least one module that is plugged into said at least one controller, said module including a wireless receiver;
c. a microprocessor in said module, said microprocessor having programming that is capable of receiving data through said receiver, and communicating with said at least one controller; and
d. said at least one controller having programming to prevent irrigation when not allowed according to input from said module.

53. The system of claim 52 wherein said central broadcasting unit is capable of accepting at least one schedule of allowed watering times provided by a government authority and broadcasting said schedule to said at least one module; and wherein said module microprocessor is capable of implementing said schedule and communicating not allowed watering times to said controller.

54. The system of claim 52 wherein said central broadcasting unit is capable of accepting at least one schedule of allowed watering times provided by a government authority, determining whether watering is allowed, and broadcasting to said at least one plug in module whether watering is allowed or not allowed according to said at least one schedule.

55. The system of claim 52 wherein said central broadcasting unit is capable of accepting at least one schedule of allowed watering times provided by a government authority, determining a periodic water budget, and broadcasting said schedule and water budget to said at least one module; and wherein said module microprocessor is capable of implementing said schedule and water budget, and communicating not allowed watering times to said controller.

56. The system of claim 52 wherein said central broadcasting unit is capable of accepting at least one schedule of allowed watering times provided by a government authority, determining whether watering is allowed, determining a periodic water budget, and broadcasting said periodic water budget to said at least one plug in module along with whether watering is allowed or not allowed according to said at least one schedule.
